(19) United States
(12) Patent Application Publication
(10) Pub. No.: US 2026/0254012 A1
(43) Pub. Date: Aug. 27, 2026

(54) SEALING MEMBER, SEALING STRUCTURE INCLUDING SEALING MEMBER, AND METHOD FOR MANUFACTURING SECONDARY BATTERY USING SEALING MEMBER

(71) Applicant: SAMSUNG SDI CO., LTD., Yongin-si (KR)

(72) Inventors: Junho BYEON, Yongin-si (KR); Byunghuy CHO, Yongin-si (KR); Soyun KIM, Yongin-si (KR); Hyojin LIM, Yongin-si (KR); Joonchul KIM, Yongin-si (KR)

(21) Appl. No.: 19/448,712

(22) Filed: Jan. 14, 2026

(30) Foreign Application Priority Data
Feb. 18, 2025 (KR) 10-2025-0021040
Feb. 18, 2025 (KR) 10-2025-0021051

(51) Int. Cl. H01M 50/186; H01M 10/658; H01M 50/197; H01M 50/198; H01M 50/645

(52) U.S. Cl. CPC H01M 50/186; H01M 10/658; H01M 50/197; H01M 50/198; H01M 50/645

(57) ABSTRACT

A sealing member includes a first sealing member and a second sealing member surrounding the first sealing member, wherein the first sealing member is configured to be disposed on an electrolyte injection port of a secondary battery, wherein the second sealing member is configured to be disposed on an outer surface of a case of the secondary battery external to the electrolyte injection port, and wherein no binder is applied to the first sealing member.

### CROSS-REFERENCE TO RELATED APPLICATIONS

The present application claims priority to and the benefit of Korean Application No. 10-2025-0021040, filed on February 18, 2025, in the Korean Intellectual Property Office, and Korean Application No. 10-2025-0021051, filed on February 18, 2025, in the Korean Intellectual Property Office, the entire disclosure of each of which is incorporated herein by reference.

### BACKGROUND

### TECHNICAL FIELD

The present disclosure relates to a sealing member, a sealing structure including the sealing member, and a method for manufacturing a secondary battery using the sealing member.

### DESCRIPTION OF THE RELATED ART

While primary batteries are not designed to be (re)charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

Some secondary batteries undergo a pre-charging process, in which an electrolyte is injected into a case then charged and discharged under heat and pressure. These secondary batteries further undergo an aging process, which allows the electrolyte to be evenly dispersed within the secondary battery. During the pre-charging and aging processes, the electrolyte may leak, contaminating the area around an electrolyte injection port, degrading enclosing performance of the electrolyte injection port.

This Background section is for the general understanding of the background of the present disclosure, and therefore, it may contain information that does not constitute related (or prior) art.

### SUMMARY

The present disclosure provides a sealing member, a sealing structure including the sealing member, and a method for manufacturing a secondary battery using the sealing member.

Embodiments of the present disclosure provide a sealing member that may include a first sealing member, and a second sealing member disposed to surround the first sealing member, wherein the first sealing member is disposed on an electrolyte injection port of a secondary battery, the second sealing member is disposed on an outer surface of a case of the secondary battery and outside the electrolyte injection port, and the first sealing member has no binder applied thereto.

Embodiments of the present disclosure provide a sealing member including a first sealing member and a second sealing member surrounding the first sealing member, wherein the first sealing member is configured to be disposed on an electrolyte injection port of a secondary battery, wherein the second sealing member is configured to be disposed on an outer surface of a case of the secondary battery external to the electrolyte injection port, and wherein no binder is applied to the first sealing member.

In some embodiments, the first sealing member is composed of a chemical-resistant material that does not react with an electrolyte injected into the case during an aging process of the secondary battery.

In some embodiments, the first sealing member includes a chemical-resistant material.

In some embodiments, the first sealing member may include a mark portion configured for aligning a position with respect to the electrolyte injection port of the secondary battery.

In some embodiments, the mark portion indicates a center of the first sealing member or at least a portion of a circumference of the first sealing member.

In some embodiments, a size of the first sealing member is greater than or equal to a size of the electrolyte injection port.

In some embodiments, the sealing member further includes a gripping portion extending from one side of the second sealing member.

In some embodiments, the first sealing member may include a concave structure in which one surface facing the electrolyte injection port is recessed.

In some embodiments, the first sealing member has a concave structure having one surface facing the electrolyte injection port recessed.

In some embodiments, the second sealing member may include a base layer, and a binder layer disposed between one surface of the base layer and the outer surface of the case, wherein the base layer is configured to be in contact with an electrolyte injected into the case.

In some embodiments, the second sealing member includes: a base layer configured to be in contact with an electrolyte injected into the case; and a binder layer configured to be disposed between one surface of the base layer and the outer surface of the case.

Embodiments of the present disclosure provide a sealing structure that may include a sealing member, and a fixing member configured to be attached to one surface of the sealing member, wherein the sealing member may include a first sealing member disposed on an electrolyte injection port of a secondary battery and having no binder applied thereto, and a second sealing member disposed to surround the first sealing member and disposed on an outer surface of a case of the secondary battery and outside the electrolyte injection port, and the fixing member may include a first fixing member attached to one surface of the sealing member, and a second fixing member disposed to surround the first fixing member and disposed on an outer surface of the case of the secondary battery and outside the second sealing member.

Embodiments of the present disclosure provide a sealing structure including: a sealing member; and a fixing member attached to one surface of the sealing member, wherein the sealing member includes: a first sealing member configured to be disposed on an electrolyte injection port of a secondary battery and having no binder applied to the first sealing member; and a second sealing member surrounding the first sealing member and configured to be disposed on an outer surface of a case of the secondary battery external to the electrolyte injection port, and wherein the fixing member includes: a first fixing member attached to one surface of the sealing member; and a second fixing member surrounding the first fixing member and disposed on the outer surface of the case external to the second sealing member.

In some embodiments, the sealing structure further includes a gripping portion extending from one side of the fixing member.

In some embodiments, the first fixing member may include a base layer and a first binder layer disposed on one surface of the base layer, and the first binder layer is adhered to one surface of the sealing member.

In some embodiments, the second fixing member may include a base layer and a second binder layer disposed on one surface of the base layer, and the second binder layer is adhered to a portion of the outer surface of the case of the secondary battery.

In some embodiments, the fixing member is composed of a heat-resistant material that is not deformed by a temperature change occurring during an aging process of the secondary battery.

In some embodiments, the fixing member includes a heat-resistant material.

In some embodiments, the fixing member may include a concave structure in which the sealing member is accommodated on one surface to which the sealing member is attached.

In some embodiments, the fixing member has a concave structure having the sealing member accommodated on one surface to which the sealing member is attached.

Embodiments of the present disclosure provide a method for manufacturing a secondary battery that may include inserting an electrode assembly into a case, injecting an electrolyte into an electrolyte injection port formed on one surface of the case, and attaching a sealing member for covering the electrolyte injection port on one surface of the case, wherein the sealing member may include a first sealing member disposed on an electrolyte injection port of a secondary battery and having no binder applied thereto, and a second sealing member disposed to surround the first sealing member and disposed on an outer surface of the case of the secondary battery and outside the electrolyte injection port.

Embodiments of the present disclosure provide a method for manufacturing a secondary battery including: disposing an electrode assembly into a case; injecting an electrolyte through an electrolyte injection port on the case; and covering the electrolyte injection port using a sealing member, wherein the sealing member includes: a first sealing member disposed on the electrolyte injection port and having no binder applied to the first sealing member; and a second sealing member surrounding the first sealing member and disposed on an outer surface of the case external to the electrolyte injection port.

In some embodiments, the first sealing member may include a mark portion for aligning a position with respect to the electrolyte injection port of the secondary battery, and the attaching the sealing member may include identifying the mark portion, and aligning the sealing member on the electrolyte injection port based on the mark portion.

In some embodiments, the first sealing member includes a mark portion for aligning a position with respect to the electrolyte injection port of the secondary battery, and wherein the covering includes: identifying the mark portion; and aligning the sealing member to the electrolyte injection port based on the mark portion.

In some embodiments, the attaching the sealing member may include identifying an electrode terminal protruding from one surface of the case where the electrolyte injection port is formed, and aligning the sealing member on the electrolyte injection port based on a position of the identified electrode terminal.

In some embodiments, the covering includes: identifying an electrode terminal protruding from one surface of the case; and aligning the sealing member to the electrolyte injection port based on a position of the electrode terminal.

In some embodiments, the sealing member further may include a gripping portion extending from one side of the second sealing member, and the method further may include removing the sealing member using the gripping portion.

In some embodiments, the method for manufacturing a secondary battery further includes injecting an electrolyte into the electrolyte injection port exposed by removal of the sealing member, and enclosing the electrolyte injection port by inserting an enclosing member into the electrolyte injection port.

In some embodiments, the method further includes: further injecting the electrolyte through the electrolyte injection port exposed by removal of the sealing member; and enclosing the electrolyte injection port via an enclosing member.

In some embodiments, the enclosing the electrolyte injection port may include welding the sealing member to the case along a welding line along a circumference of the electrolyte injection port, and a size of the first sealing member is greater than the welding line.

In some embodiments, the enclosing includes welding the sealing member to the case.

According to some embodiments of the present disclosure, a sealing member that can be repeatedly attached and removed without leaving residue around an electrolyte injection port is used, thereby allowing an electrolyte to be continuously replenished in a secondary battery as many times as needed.

According to some embodiments of the present disclosure, based on a mark portion formed on a sealing member, the sealing member is aligned at an accurate position on an electrolyte injection port, thereby preventing the electrolyte injection port from being contaminated by a binder. Accordingly, an enclosing force may be prevented from being degraded by binder residue during a process of coupling a enclosing member for sealing the electrolyte injection port to the electrolyte injection port.

According to some embodiments of the present disclosure, because a gripping portion is formed on one side of a sealing member, the sealing member may be easily removed from a case of a secondary battery.

According to some embodiments of the present disclosure, opening and closing of an electrolyte injection port are facilitated by easy removal and reattachment of a sealing structure during an aging process, thereby reducing an electrolyte injection process time. In addition, damage to the electrolyte injection port and a surrounding case structure is prevented by the sealing structure, thereby ensuring stability and durability of a battery even during the aging process.

According to some embodiments of the present disclosure, a concave structure of a sealing structure may provide a constant buffer space between an electrolyte injection port and a sealing member. The buffer space provided by the concave structure may alleviate pressure applied to the sealing member by gas generated during an aging process, thereby allowing an adhesion state between the sealing member and the electrolyte injection port to be stably maintained.

### BRIEF DESCRIPTION OF THE DRAWINGS

The drawings illustrate embodiments of the present disclosure and, together with the detailed description of the present disclosure, further describe aspects and features of the present disclosure. Accordingly, the present disclosure should not be construed as being limited to the drawings.

FIG. 1 is a perspective view illustrating a secondary battery according to embodiments of the present disclosure.

FIG. 2 is a cross-sectional view illustrating a secondary battery according to embodiments of the present disclosure.

FIG. 3 is a diagram illustrating a sealing member according to embodiments of the present disclosure.

FIG. 4 is a diagram illustrating the sealing member being attached according to embodiments of the present disclosure.

FIG. 5 is a diagram illustrating a sealing member according to embodiments of the present disclosure.

FIG. 6 is a diagram illustrating the sealing member being attached according to embodiments of the present disclosure.

FIG. 7 is a diagram illustrating a sealing member according to embodiments of the present disclosure.

FIG. 8 is a diagram illustrating the sealing member being attached according to embodiments of the present disclosure.

FIG. 9 is a diagram illustrating a sealing member including a gripping portion according to embodiments of the present disclosure.

FIG. 10 is a cross-sectional view of a sealing structure according to embodiments of the present disclosure.

FIG. 11 is a diagram of a sealing member according to embodiments of the present disclosure.

FIG. 12 is a cross-sectional view of a sealing structure including the sealing member of FIG. 11.

FIG. 13 is a diagram of a sealing member according to embodiments of the present disclosure.

FIG. 14 is a diagram of a sealing structure according to embodiments of the present disclosure.

FIG. 15 is a diagram of a sealing structure according to embodiments of the present disclosure.

FIG. 16 is a diagram illustrating a process in which a sealing structure is removed according to embodiments of the present disclosure.

FIG. 17 is a diagram illustrating a process in which a sealing structure is removed according to embodiments of the present disclosure.

FIG. 18 is a diagram of a sealing structure according to embodiments of the present disclosure.

FIG. 19 is a diagram illustrating a sealing member including a gripping portion being attached to a case according to embodiments of the present disclosure.

FIG. 20 is a diagram illustrating a sealing member including a gripping portion being attached to a case according to embodiments of the present disclosure.

FIG. 21 is a diagram illustrating a sealing member including a gripping portion being attached to a case according to embodiments of the present disclosure.

FIG. 22 is a diagram illustrating a process of removing a sealing member according to embodiments of the present disclosure.

FIG. 23 is a diagram illustrating a process of removing a sealing member according to embodiments of the present disclosure.

FIG. 24 is a diagram illustrating a process of removing a sealing structure according to embodiments of the present disclosure.

FIG. 25 is a diagram illustrating a process of manufacturing a secondary battery according to embodiments of the present disclosure.

FIG. 26 is a diagram illustrating a method for manufacturing a secondary battery using a sealing structure according to embodiments of the present disclosure.

FIG. 27 is a diagram illustrating a method for manufacturing a secondary battery using a sealing structure according to embodiments of the present disclosure.

FIG. 28 is a flowchart illustrating a method for manufacturing a secondary battery according to embodiments of the present disclosure.

FIG. 29 is a flowchart illustrating a method for manufacturing a secondary battery according to embodiments of the present disclosure.

### DETAILED DESCRIPTION

Hereinafter, preferred embodiments of the present disclosure will be described in detail with reference to the accompanying drawings. Prior to this, the terms and words used in the present specification and claims should not be construed as being limited to ordinary or dictionary meanings, and the inventor should interpret them as meanings and concepts consistent with the technical idea of the present disclosure based on the principle that the inventor can appropriately define the concepts of terms in order to explain his or her invention in the best way. Therefore, it should be understood that the embodiments described in the present specification and the configurations shown in the drawings are only some of the most preferred embodiments of the present disclosure and do not represent all of the technical ideas of the present disclosure, and various equivalents and modifications that can replace them may exist at the time of filing the present application.It will be understood that when an element or layer is referred to as being “on,” “connected to,” or “coupled to” another element or layer, the element or layer may be directly on, connected to, or coupled to the other element or layer, or one or more intervening elements or layers may be present. When an element or layer is referred to as being “directly on,” “directly connected to,” or “directly coupled to” another element or layer, no intervening elements or layers are present. For example, when a first element is described as being “coupled” or “connected” to a second element, the first element may be directly coupled or connected to the second element or may be indirectly coupled or connected to the second element via one or more intervening elements.

To facilitate understanding of the disclosure, the attached drawings are not drawn to actual scale and the dimensions of some components may be exaggerated. Furthermore, the same reference numbers may be assigned to the same components in different embodiments. As used herein, the term “and/or” includes any and all combinations of one or more of the associated listed items. Further, the use of “may” when describing embodiments of the present disclosure relates to “one or more embodiments of the present disclosure.” Expressions such as “at least one of” and “any one of,” when preceding a list of elements, modify the entire list of elements and do not modify the individual elements of the list. When phrases such as “at least one of A, B and C,” “at least one of A, B or C,” “at least one selected from a group of A, B and C,” or “at least one selected from among A, B and C” are used to designate a list of elements A, B and C, the phrases may refer to any and all suitable combinations or subsets of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and are not terms of degree and are intended to account for inherent variations in measured or calculated values that would be recognized by a person of ordinary skill in the art.

Also, as used herein, "comprise," "including” and/or "comprising," "including" specify the presence of stated shapes, numbers, steps, operations, members, elements and/or groups thereof, but do not exclude the presence or addition of one or more other shapes, numbers, operations, members, elements and/or groups thereof.

The mention that two comparison objects are "identical" means that they are "substantially identical". Therefore, substantial identity may include cases having a deviation considered low in the art, for example, a deviation within 5%. In addition, a parameter being uniform in a certain region may mean being uniform from an average point of view.

Although first, second, etc., are used to describe various components, these components are not limited by these terms. These terms are used only to distinguish one component from another, and unless stated to the contrary, the first component may also be a second component.

Throughout the specification, unless stated to the contrary, each component may be singular or plural.

Spatially relative terms, such as “beneath,” “below,” “lower,” “above,” “upper,” and the like, may be used herein for ease of description to describe a positional relationship of one element or feature to another element or feature as illustrated in the figures. It will be understood that the spatially relative terms are intended to encompass different orientations of a device in use or operation in addition to the orientation depicted in the figures. For example, if the device in the figures is turned over, elements described as being “below” or “beneath” other elements or features would then be oriented “above” or “over” the other elements or features. Thus, the term “below” may encompass both above and below orientations. The device may be otherwise oriented (for example, rotated 90 degrees or at other orientations), and the spatially relative descriptors used herein should be interpreted accordingly.

Also, any numerical range disclosed or recited herein is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited herein is intended to include all higher numerical limitations subsumed therein. Accordingly, the applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a) and 35 U.S.C. § 132(a).

In addition, if it is stated that a component is "connected," "coupled," or "joined" to another component, it should be understood that the components may be directly connected or joined to each other, but also that other components may be "interposed" between the components, or that the components may be "connected," "coupled," or "joined" through other components. In addition, if a portion is said to be electrically coupled to another portion, this includes not only cases where they are directly connected, but also cases where other elements are interposed therebetween.

Arranging an arbitrary element “above (or below)” or “on (under)” another element may mean that the arbitrary element is disposed in contact with an upper (or lower) surface of the other element, and another element may be interposed between the arbitrary element and the other element disposed on (or under) the other element.

Throughout the specification, "A and/or B" means A, B, or A and B, unless otherwise specified. That is, "and/or" includes all combinations or any combination of a plurality of enumerated items. If "C to D" is referred to, it means greater than or equal to C and less than or equal to D, unless there is a specific contrary description.

The terms used in the present specification are for describing embodiments of the present disclosure and are not intended to limit the present disclosure.

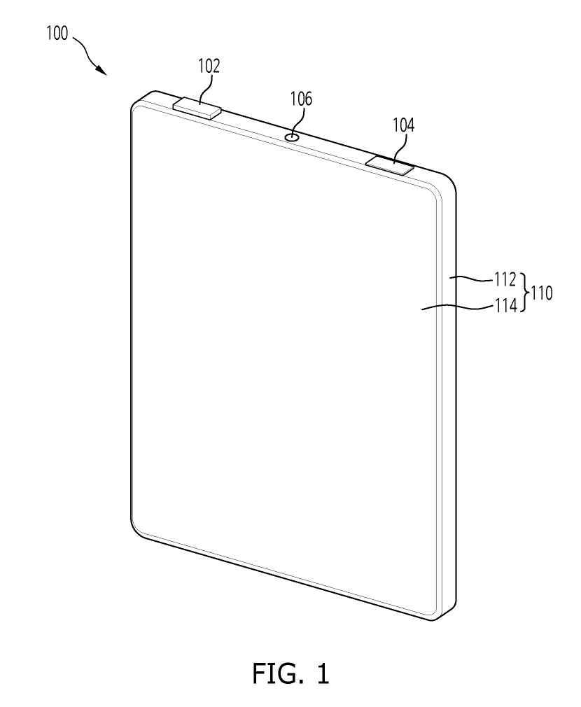

FIG. 1 is a perspective view illustrating a secondary battery 100. As shown, the secondary battery 100 may include a case 110, electrode terminals 102, 104, and an electrolyte injection port 106.

The case 110 forms an overall appearance of the secondary battery 100 and may provide a space for accommodating an electrode assembly. The case 110 may include a conductive metal such as stainless steel (e.g., steel use stainless (SUS)), aluminum, an aluminum alloy, or nickel-plated steel, or a laminate film or plastic forming a pouch, but is not limited thereto.

The case 110 may include a case body 112 and a case cover 114. The case body 112 may define an internal space for accommodating an electrode assembly and an electrolyte. For example, the case body 112 may be a substantially rectangular parallelepiped container having an opening formed on one surface. Accordingly, the electrode assembly may be inserted through the opening of the case body 112.

In an embodiment, the case body 112 may be coupled to the case cover 114. For example, the case body 112 may include a flange protruding outward along an edge of the opening. The case cover 114 may be welded while being disposed on the flange of the case body 112 to seal the opening of the case body 112.

In an embodiment, the electrode terminals 102, 104 may be disposed on one surface of the case 110. For example, a first electrode terminal 102 and/or a second electrode terminal 104 may be formed to protrude from one surface of the case 110. If the first electrode terminal 102 is a positive electrode terminal, the second electrode terminal 104 may be a negative electrode terminal. Alternatively, if the first electrode terminal 102 is a negative electrode terminal, the second electrode terminal 104 may be a positive electrode terminal. The geometries of the first electrode terminal 102 and the second electrode terminal 104 may be implemented in various forms such as plates or rivets, and the geometries and/or sizes are not limited to those shown. In addition, if the case 110 includes a metal material, the case 110 itself may serve as an electrode terminal.

In an embodiment, an electrolyte injection port 106 may be formed on one surface of the case 110. The electrolyte injection port 106 may be a through-hole. After an electrolyte is injected into the case 110 through the electrolyte injection port 106, a pre-charging and/or aging process may be performed for moisture absorption of the electrolyte, and the electrolyte injection port 106 may be enclosed by an enclosing member. If the pre-charging and/or aging process is completed, additional electrolyte may be injected, then the electrolyte injection port 106 may be enclosed by the enclosing member.

In FIG. 1, the first electrode terminal 102, the second electrode terminal 104, and the electrolyte injection port 106 are shown as being formed on one surface of the case 110, but the structure of the secondary battery 100 is not limited thereto. For example, the first electrode terminal 102, the second electrode terminal 104, and/or the electrolyte injection port 106 may be formed on different surfaces of the case, respectively. Alternatively, the first electrode terminal 102, the second electrode terminal 104, and/or the electrolyte injection port 106 may not be formed on the case 110, and a separate cap plate on which the first electrode terminal 102, the second electrode terminal 104, and/or the electrolyte injection port 106 are formed may be coupled to the case 110.

In FIG. 1, the case 110 is a prismatic case, and the secondary battery 100 is shown as a prismatic secondary battery, but the scope of the present disclosure is not limited thereto. The secondary battery 100 may be a secondary battery of any geometry, such as prismatic, cylindrical, or pouch type.

In an embodiment, the secondary battery 100 may be a lithium secondary battery or a sodium secondary battery. However, the scope of the present disclosure is not limited thereto, and the secondary battery 100 may include any battery that can repeatedly provide electricity by charging and discharging.

The configuration of the secondary battery 100 shown in FIG. 1 is merely an example, and in some embodiments, other configurations may be additionally included, and some configurations may be omitted. In addition, the geometry or positional relationship of each component of the secondary battery 100 shown in FIG. 1 may be changed in various ways.

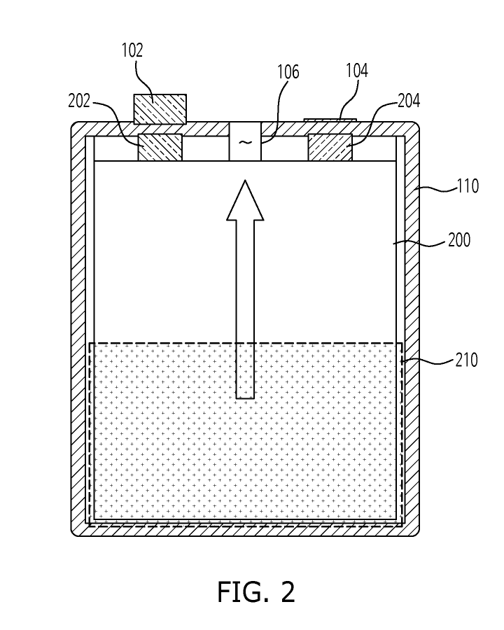

FIG. 2 is a cross-sectional view illustrating a secondary battery 100. As shown, the secondary battery 100 may include a case 110 and an electrode assembly 200 accommodated inside the case 110.

The electrode assembly 200 may include a first electrode, a second electrode, and a separator interposed between them. The first electrode and the second electrode may be wound after interposing a separator, which is an insulator, between them. However, the present disclosure is not limited thereto, and the electrode assembly may have a structure in which a plurality of sheets of the first electrode and the second electrode are alternately stacked with a separator interposed therebetween.

Each of the first electrode and the second electrode may include a base, a mixture portion where an active material is disposed on the base, and an uncoated portion where the base is exposed without an active material disposed thereon. In an embodiment, the first electrode may function as a positive electrode, and the second electrode may function as a negative electrode, and vice versa.

The separator may allow migration of lithium ions and prevent short circuits between the first electrode and the second electrode. The separator may include, for example, a polyethylene film, a polypropylene film, or a polyethylene-polypropylene film, but is not limited thereto.

A first electrode tab 202 electrically connected to the uncoated portion may be formed or connected on one side of the first electrode. For example, the first electrode tab 202 may be a base tab that uses a portion of the uncoated portion. Additionally or alternatively, a plurality of first electrode tabs 202 may be formed or connected on one side of the first electrode, and the plurality of first electrode tabs 202 may be connected to form a lead tab.

A second electrode tab 204 electrically connected to the uncoated portion may be formed or connected on one side of the second electrode. For example, the second electrode tab 204 may be a base tab that uses a portion of the uncoated portion. Additionally or alternatively, a plurality of second electrode tabs 204 may be formed or connected on one side of the second electrode, and the plurality of second electrode tabs 204 may be connected to form a lead tab.

The first electrode tab 202 may be connected to the first electrode terminal 102. The first electrode tab 202 may function as a current flow path between the first electrode terminal 102 and the first electrode.

The second electrode tab 204 may be connected to the second electrode terminal 104. The second electrode tab 204 may function as a current flow path between the second electrode terminal 104 and the second electrode. Additionally or alternatively, the second electrode tab 204 may be directly connected to the case 110, and the case 110 itself may perform the function of an electrode terminal.

An electrolyte 210 may be injected into the case 110 accommodating the electrode assembly 200. The electrolyte 210 is an electrolyte in a liquid state, and may provide an ion migration path between a positive electrode and a negative electrode to facilitate a smooth battery reaction. In addition, the electrolyte 210 may stabilize a surface of the electrode to improve life characteristics of the secondary battery 100.

The electrolyte 210 may be injected into the case 110 through the electrolyte injection port 106. The electrolyte injection port 106 may be in the form of a through-hole penetrating an inside and an outside of the case 110. After the injection of the electrolyte 210 is completed, the secondary battery 100 may be enclosed by inserting a enclosing member (not shown) into the electrolyte injection port 106. For example, the enclosing member may be in the form of a ball, a rivet, or a pin, having a diameter greater than that of the electrolyte injection port 106, and the electrolyte injection port 106 may be enclosed by mechanically pressing the enclosing member into the electrolyte injection port 106.

Additionally or alternatively, the sealing member may be welded to the electrolyte injection port 106. For example, the electrolyte injection port 106 may be enclosed by welding an enclosing member inserted into or covering the electrolyte injection port 106 along a welding line following a circumference of the electrolyte injection port 106.

In an embodiment, the electrolyte 210 may be injected at least twice. For example, the secondary battery 100 into which the electrolyte 210 has been primarily injected may undergo a pre-charging and/or aging process. In this manner, an initial chemical reaction between the electrolyte 210 and the electrode assembly 200 may be induced, and the electrolyte 210 may uniformly penetrate into the electrode assembly 200. Thereafter, the electrolyte 210 may be secondarily injected into the secondary battery 100 to replenish the electrolyte 210 lost or consumed during the pre-charging and/or aging process.

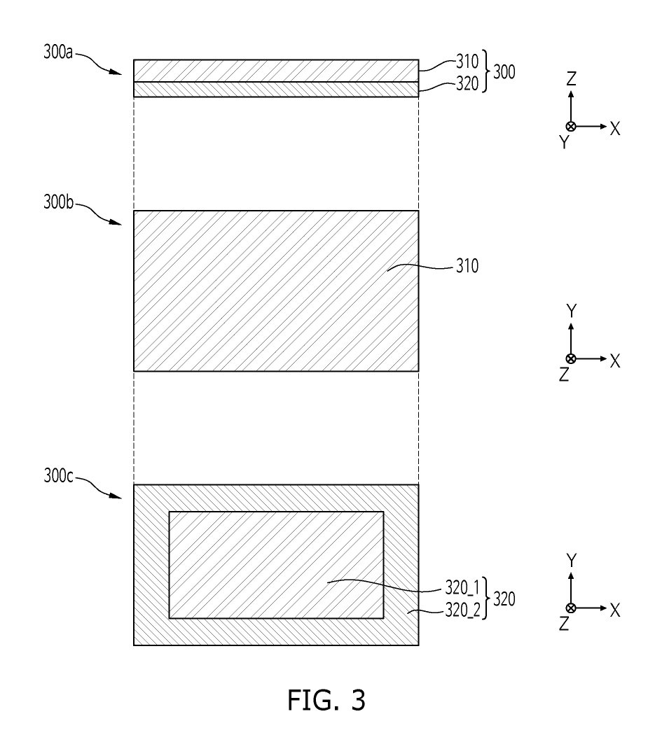

In an embodiment, during the pre-charging and/or aging process of the secondary battery 100, the electrolyte injection port 106 may be temporarily sealed by a sealing member or a sealing structure described with reference to FIGS. 3-29. Accordingly, leakage of the electrolyte 210 or introduction of foreign matter through the electrolyte injection port 106 may be prevented during the pre-charging and/or aging process. If the pre-charging and/or aging process of the secondary battery 100 is completed, the sealing member or the sealing structure may be removed from the electrolyte injection port 106, and the electrolyte 210 may be additionally injected.

If a sealing member is mechanically pressed or welded to the electrolyte injection port 106, similar to an enclosing member, removal thereof may be difficult. In particular, if a plug-type sealing member is pressed into the electrolyte injection port 106, the case 110 around the electrolyte injection port 106 may be contaminated or the electrolyte 210 may leak during the removal process of the sealing member. In this manner, during the process of coupling the enclosing member to the electrolyte injection port 106, the enclosing performance of the enclosing member may be degraded. In addition, as secondary batteries become smaller and thinner, there is a risk of damaging the case 110 during the process of removing the sealing member.

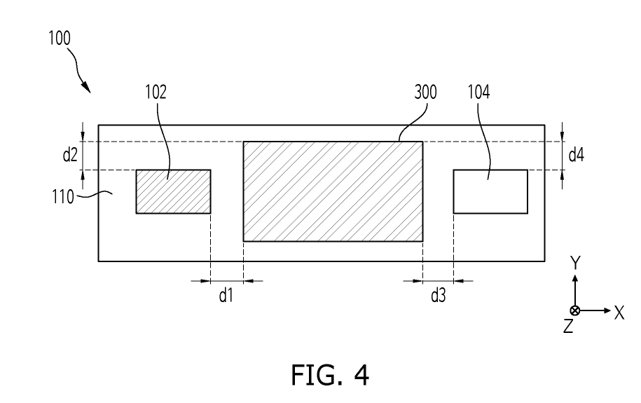

FIG. 3 is a diagram illustrating a sealing member 300, and FIG. 4 is a diagram illustrating the sealing member 300 being attached. Side view 300a of FIG. 3 illustrates a side surface (e.g., a +Y direction surface) of the sealing member 300, plan view 300b illustrates an upper surface (e.g., a +Z direction surface) of the sealing member 300, and plan view 300c illustrates a lower surface (e.g., a -Z direction surface) of the sealing member 300.

Referring to FIG. 3, the sealing member 300 may include a base layer 310 and a binder layer 320 disposed on one surface of the base layer 310. For example, the sealing member 300 may have a structure in which a binder layer 320, including an adhesive material, is coupled to a base layer 310 including a polymer material. The base layer 310 may include a material having heat resistance and chemical resistance. For example, at least a portion of the base layer 310 may include polyimide (PI) or polypropylene (PP), but is not limited thereto.

In an embodiment, the binder layer 320 may have a structure in which a binder is applied to a portion of one surface of the base layer 310. For example, the sealing member 300 may include a first sealing member 320_1, which is not coated with a binder and exposes the base layer 310, and a second sealing member 320_2, which is coated with a binder and surrounds the first sealing member 320_1. That is, the first sealing member 320_1, which exposes the base layer 310, may include a chemical-resistant material that does not react with an electrolyte when the electrolyte is injected into a case during an aging process of a secondary battery.

In FIG. 3, the first sealing member 320_1 is shown as being rectangular, but is not limited thereto. For example, the first sealing member 320_1 may have various geometries such as a circle, an ellipse, or a polygon. In addition, the geometry of the first sealing member 320_1 may correspond to the geometry of an electrolyte injection port.

Referring to FIG. 4, the sealing member 300 may be attached to one surface of the case 110 to cover an electrolyte injection port.

In an embodiment, the first sealing member 320_1 is disposed on an electrolyte injection port, and the second sealing member 320_2 may be spaced apart from the electrolyte injection port. That is, the electrolyte injection port may be in contact with the first sealing member 320_1 where no binder is applied.

In an embodiment, the sealing member 300 may be attached to a specific position of the case 110. Specifically, the sealing member 300 may be aligned such that the first sealing member 320_1 is disposed on an electrolyte injection port, and the second sealing member 320_2 is spaced apart from the electrolyte injection port by a predetermined length or more. That is, the electrolyte injection port may be in contact only with the first sealing member 320_1 where no binder is applied. Accordingly, contamination of the electrolyte injection port by residual foreign matter of the binder, during the removal process of the sealing member 300, may be prevented.

In an embodiment, the sealing member 300 may be aligned based on positions of components of the secondary battery 100 disposed adjacent to an electrolyte injection port. For example, an apparatus for manufacturing a secondary battery 100 may include a device such as a vision camera. Accordingly, the apparatus may identify components of the secondary battery 100, and the apparatus may align the sealing member 300 on an electrolyte injection port based on positions of the identified components.

For example, the sealing member 300 may be aligned based on positions of electrode terminals 102, 104. The apparatus may identify a first electrode terminal 102 protruding from one surface of the case 110 where an electrolyte injection port is formed. Thereafter, the apparatus may detect a distance d1 in a first direction (e.g., X direction) and/or a distance d2 in a second direction (e.g., Y direction) intersecting the first direction between the identified first electrode terminal 102 and the sealing member 300, and the apparatus may align the sealing member 300 on an electrolyte injection port based on the detected distances.

Additionally or alternatively, the apparatus may identify a second electrode terminal 104 protruding from one surface of the case 110 where an electrolyte injection port is formed. Thereafter, the apparatus may detect a distance d3 in a first direction (e.g., X direction) and/or a distance d4 in a second direction (e.g., Y direction) intersecting the first direction between the identified second electrode terminal 104 and the sealing member 300, and align the sealing member 300 on an electrolyte injection port based on the detected distances.

In FIG. 4, the sealing member 300 is aligned based on positions of the first electrode terminal 102 and the second electrode terminal 104, but a component serving as a reference for aligning the sealing member 300 is not limited thereto. For example, with reference to FIGS. 3 and 4, the sealing member 300 may be aligned by additionally or alternatively considering positions of various components whose positions are identified by the apparatus.

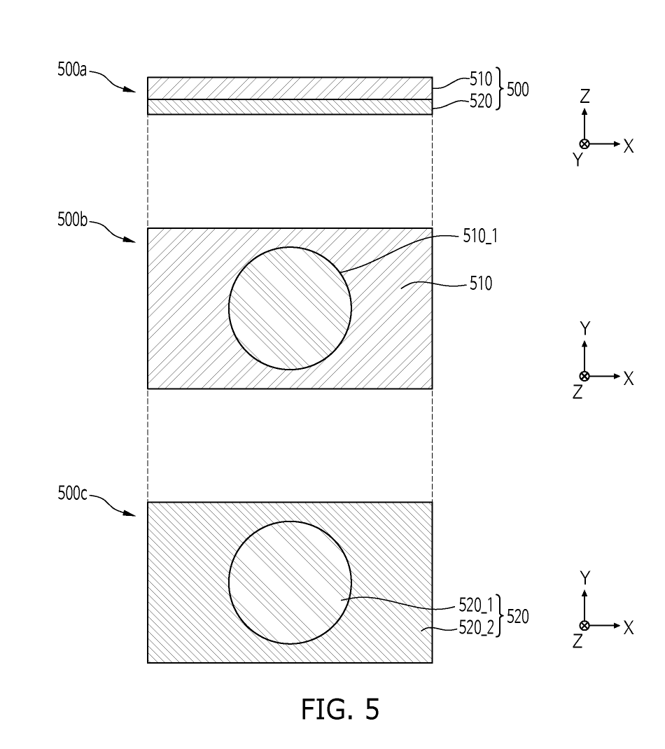

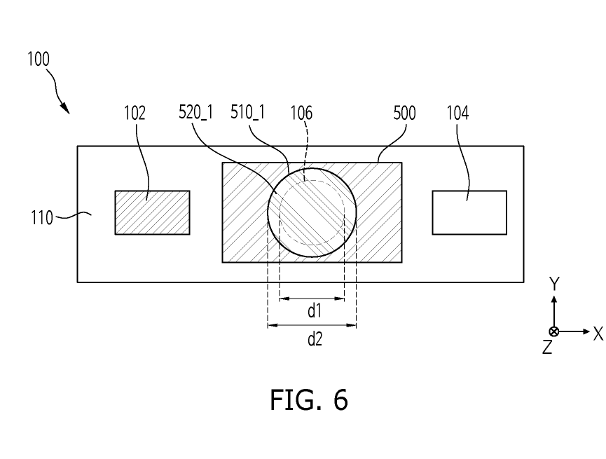

FIG. 5 is a diagram illustrating a sealing member 500, and FIG. 6 is a diagram illustrating the sealing member 500 being attached. Side view 500a of FIG. 5 illustrates a side surface (e.g., a +Y direction surface) of the sealing member 500, plan view 500b illustrates an upper surface (e.g., a +Z direction surface) of the sealing member 500, and plan view 500c illustrates a lower surface (e.g., a -Z direction surface) of the sealing member 500.

Referring to FIG. 5, the sealing member 500 may include a base layer 510 and a binder layer 520 in which a binder is applied to a portion of one surface of the base layer 510. For example, the sealing member 500 may include a first sealing member 520_1 where the base layer 510 is exposed without a binder applied, and a second sealing member 520_2 where a binder is applied and which is arranged to surround the first sealing member 520_1.

The base layer 510 of the first sealing member 520_1 may include a mark portion 510_1 for aligning a position of the sealing member 500. The mark portion 510_1 may serve as a reference for aligning a position of the first sealing member 520_1 with respect to an electrolyte injection port of a secondary battery.

In an embodiment, the mark portion 510_1 may indicate at least a portion of a circumference of the first sealing member 520_1. For example, the mark portion 510_1 may indicate a boundary between the first sealing member 520_1 and the second sealing member 520_2. Additionally, a color of the first sealing member 520_1 of the sealing member 500 and a color of the second sealing member 520_2 may be different from each other.

Referring to FIG. 6, the sealing member 500 may be aligned on the electrolyte injection port 106. In an embodiment, a size of the first sealing member 520_1 may be equal to or greater than a size of the electrolyte injection port 106. Accordingly, the sealing member 500 may be aligned such that a position of the electrolyte injection port 106 matches a boundary of the first sealing member 520_1 or is located inside the first sealing member 520_1. For example, a width d1 of the first sealing member 520_1 may be about 2 mm to about 4 mm greater than a width d2 of the electrolyte injection port 106, but is not limited thereto, and may be changed in various ways depending on a size according to a type of the secondary battery 100.

In an embodiment, the sealing member 500 may be aligned on the electrolyte injection port 106 based on the mark portion 510_1. For example, the mark portion 510_1 may be identified on a surface of the base layer 510 opposite to one surface of the base layer 510 facing the electrolyte injection port 106.

For example, at least a portion of a circumference of the first sealing member 520_1 may be identified on the other surface of the base layer 510. Additionally, the first sealing member 520_1 and the second sealing member may be identified by different colors on the other surface of the base layer 510. The first sealing member 520_1 may be made of a transparent or translucent material, but is not limited thereto. Accordingly, positions of the mark portion 510_1 and the electrolyte injection port 106, and/or relative positions of the mark portion 510_1 and the electrolyte injection port 106, etc., may be accurately identified by a device such as a vision camera.

In FIG. 6, the sealing member 500 is aligned based on the mark portion 510_1, but a component serving as a reference for aligning the sealing member 300 is not limited thereto. For example, with reference to FIGS. 3 and 4, positions of the electrode terminals 102, 104 may be additionally or alternatively considered to align the sealing member 300.

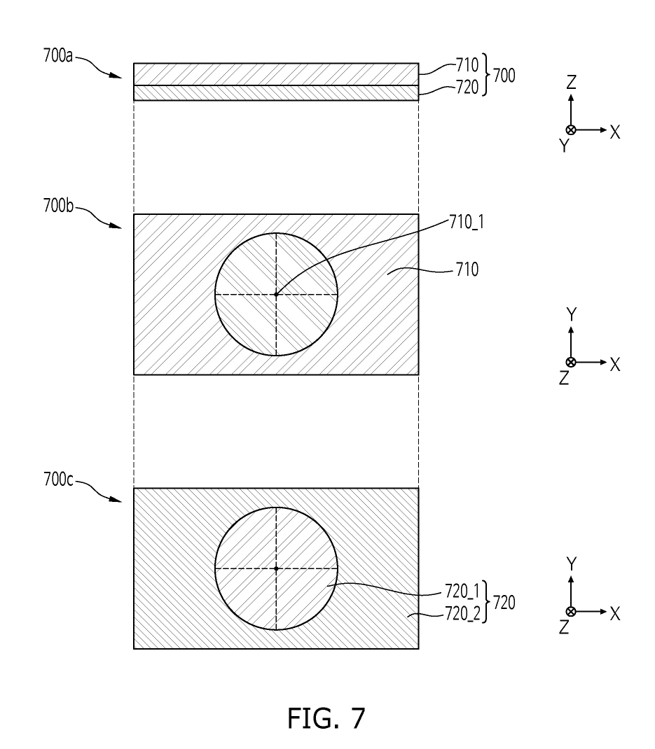

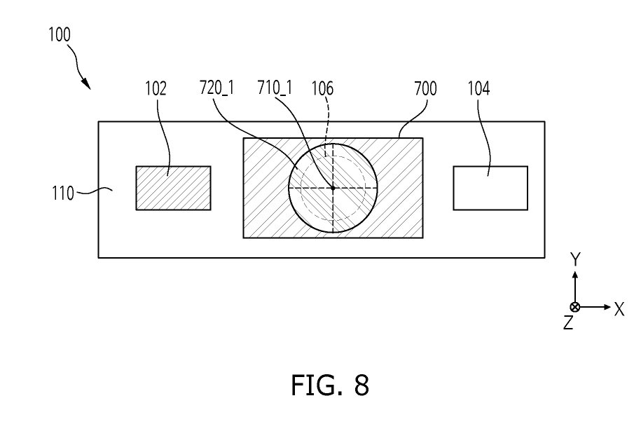

FIG. 7 is a diagram illustrating a sealing member 700, and FIG. 8 is a diagram illustrating the sealing member 700 being attached. Side view 700aof FIG. 7 illustrates a side surface (e.g., a +Y direction surface) of the sealing member 700, plan view 700b illustrates an upper surface (e.g., a +Z direction surface) of the sealing member 700, and plan view 700c illustrates a lower surface (e.g., a -Z direction surface) of the sealing member 700.

Referring to FIG. 7, the sealing member 700 may include a base layer 710 and a binder layer 720 in which a binder is applied to a portion of one surface of the base layer 710. For example, the sealing member 700 may include a first sealing member 720_1 where the base layer 710 is exposed without a binder applied, and a second sealing member 720_2 where a binder is applied and which is arranged to surround the first sealing member 720_1.

The base layer 710 of the first sealing member 720_1 may include a mark portion 710_1 for aligning a position of the first sealing member 520_1 with respect to an electrolyte injection port of a secondary battery. The mark portion 710_1 may indicate a center and/or a center line of the first sealing member 720_1.

Referring to FIG. 8, the sealing member 700 may be aligned on the electrolyte injection port 106 based on the mark portion 710_1. The mark portion 710_1 may be identified on a surface of the base layer 710 opposite to one surface of the base layer 710 facing the electrolyte injection port 106. For example, a center of the first sealing member 720_1 may be identified on the other surface of the base layer 710. The first sealing member 720_1 may be made of a transparent or translucent material. Accordingly, positions of the mark portion 710_1 and the electrolyte injection port 106, and/or relative positions of the mark portion 710_1 and a center of the electrolyte injection port 106 may be accurately identified by a device such as a vision camera.

In FIGS. 3-9, the first sealing members 320_1, 520_1, and 720_1 are shown as having flat surfaces facing the electrolyte injection port 106, but the structure of the first sealing members 320_1, 520_1, and 720_1 is not limited thereto. For example, the first sealing member may include a concave structure in which one surface facing the electrolyte injection port 106 is recessed.

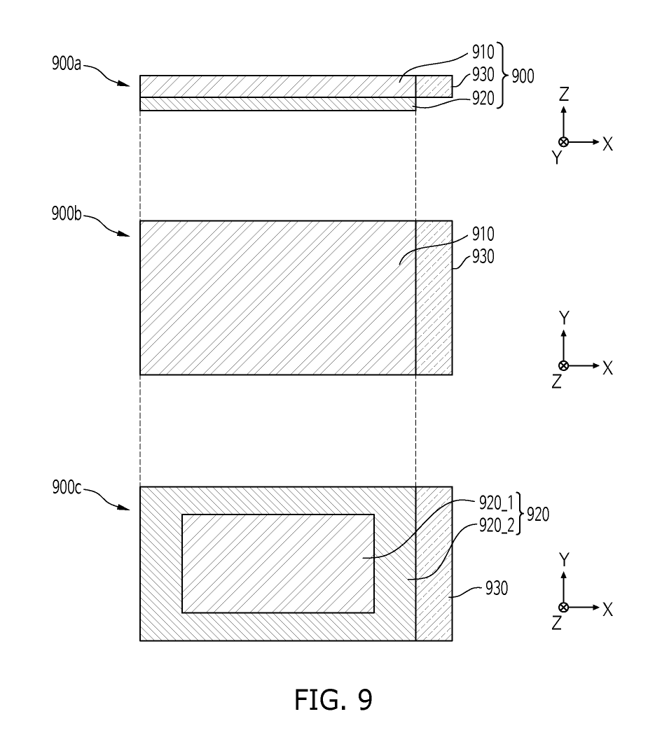

FIG. 9 is a diagram illustrating a sealing member 900 including a gripping portion. Side view 900a of FIG. 9 illustrates a side surface (e.g., a +Y direction surface) of the sealing member 900, plan view 900b illustrates an upper surface (e.g., a +Z direction surface) of the sealing member 900, and plan view 900c illustrates a lower surface (e.g., a -Z direction surface) of the sealing member 900.

The sealing member 900 may include a base layer 910 and a binder layer 920 in which a binder is applied to a portion of one surface of the base layer 910. In addition, the sealing member 900 may include a first sealing member 920_1 where the base layer 910 is exposed without a binder applied, and a second sealing member 920_2 where a binder is applied and surrounds the first sealing member 920_1.

The sealing member 900 may include a gripping portion 930. The gripping portion 930 may extend from one side of the sealing member 900. For example, the gripping portion 930 may extend from one side of the second sealing member 920_2. Accordingly, the sealing member 900 may be easily removed from a case of a secondary battery through the gripping portion 930.

In FIG. 9, the gripping portion 930 is shown as extending along a longitudinal direction (e.g., +X direction) of the sealing member 900 with the same width as the sealing member 900, but the geometry and/or arrangement direction of the sealing member 900 are not limited thereto.

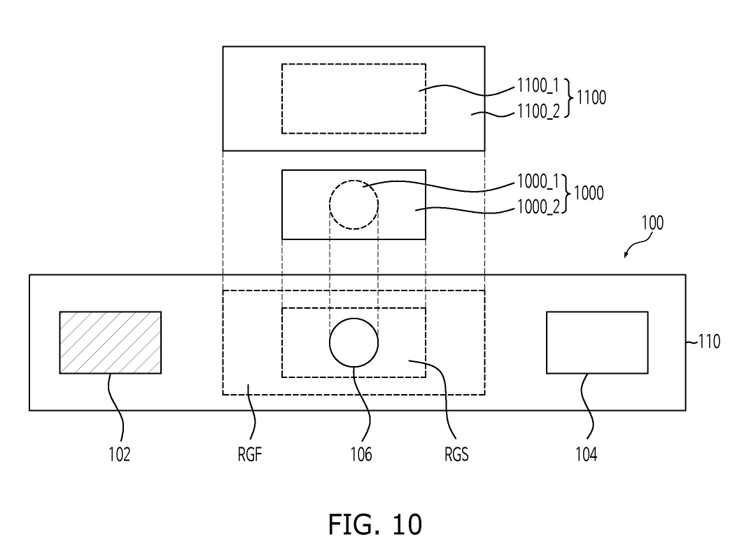

FIG. 10 is a cross-sectional view of a sealing structure.

A sealing structure may include a sealing member 1000 and a fixing member 1100 configured to be attached to one surface of the sealing member 1000. The sealing member 1000 may be substantially the same as the sealing member described in FIGS. 3-9, but is not limited thereto.

Referring to FIG. 10, the sealing structure may be disposed on an electrolyte injection port 106, spaced apart by a predetermined distance from electrode terminals 102, 104 formed on one surface of the case 110 or from through-holes where the electrode terminals 102, 104 are disposed. However, the method of disposing the sealing structure is not limited thereto, and may be disposed in various ways within a range that does not restrict the function of the electrode terminals 102, 104 to maintain a current path with the outside.

In an embodiment, the sealing member 1000 may seal the electrolyte injection port 106. Referring to FIG. 10, the sealing member 1000 may include a first sealing member 1000_1 disposed on an electrolyte injection port 106 of a secondary battery 100, and a second sealing member 1000_2 disposed to surround the first sealing member 1000_1 and disposed in an outer region RGS of the electrolyte injection port 106 on an outer surface of a case 110 of the secondary battery 100.

In an embodiment, the first sealing member 1000_1 may be disposed on the electrolyte injection port 106. A cross section of the first sealing member 1000_1 may correspond to a size and/or a shape of the electrolyte injection port 106. The electrolyte injection port 106 formed in the case 110 of the secondary battery 100 may have a circular geometry, and a cross section of the first sealing member 1000_1 may have a circular geometry of the same size as the electrolyte injection port 106. However, a size and/or a geometry of a cross section of the first sealing member 1000_1 are not limited thereto. The cross section of the first sealing member 1000_1 may have various geometries to cover the electrolyte injection port 106. For example, the first sealing member 1000_1 may have a polygonal cross section, such as a circle larger than the electrolyte injection port 106 or a rectangle including the circular electrolyte injection port 106.

In an embodiment, the second sealing member 1000_2 may have a surface geometry corresponding to an outer surface of the case 110. The second sealing member 1000_2 extends outward from the first sealing member 1000_1 and may be disposed or attached to an outer region RGS of the electrolyte injection port 106 on the outer surface of the case 110. The second sealing member 1000_2 may be in close contact with a portion of the outer surface of the case 110. For example, the second sealing member 1000_2 may have a certain roughness on its surface to stably adhere to the outer surface of the case 110. In addition, the second sealing member 1000_2 may have a predetermined elasticity, and may be deformed to match a curvature of the outer surface of the case 110. In addition, the second sealing member 1000_2 may have a predetermined thermal expansion characteristic, and may be in close contact with the outer surface of the case 110 even when structural changes of the case 110 occur during the aging process due to thermal expansion or pressure changes. The structure of the second sealing member 1000_2 may allow the first sealing member 1000_1 to stably seal the electrolyte injection port 106 and prevent leakage of an electrolyte and/or gas to the outside during the aging process.

In an embodiment, the sealing member 1000 may include a chemical-resistant material to an electrolyte and/or gas. The sealing member 1000 may come into contact with an electrolyte to prevent leakage of the electrolyte and maintain enclosing ability inside a battery. The sealing member 1000 may include a chemical-resistant material that does not react with an electrolyte injected into the case 110 during an aging process of the secondary battery 100. In addition, the sealing member 1000 may include a material that does not react with gas generated during the aging process. For example, the sealing member 1000 may include a polymer material such as polyimide (PI), polypropylene (PP), or polyethylene (PE), or stainless use steel. The sealing member 1000 may minimize interaction with an electrolyte and/or gas during the aging process, and stably maintain an internal environment of the case 110 of the secondary battery 100.

In an embodiment, the fixing member 1100 may adhere and/or fix the sealing member 1000 to an outer surface of the case 110. The fixing member 1100 may include a first fixing member 1100_1 attached to one surface of the first sealing member 1000_1, and a second fixing member 1100_2 surrounding the first fixing member 1100_1 and disposed in an outer region RGF of the second sealing member 1000_2 on an outer surface of the case 110 of the secondary battery 100.

In an embodiment, the first fixing member 1100_1 may be adhered to one surface of the sealing member 1000. The first fixing member 1100_1 may include a base layer and a first binder layer disposed on one surface of the base layer. The first binder layer may be adhered to one surface of the sealing member. For example, the first fixing member 1100_1 may be adhered to one surface of the sealing member 1000 by applying a binder such as an adhesive material to one surface thereof. For example, the first fixing member 1100_1 may include an elastic material such as rubber or silicone, and may be adhered to the sealing member 1000 via compression.

In an embodiment, the second fixing member 1100_2 may include a base layer and a second binder layer disposed on one surface of the base layer. The second binder layer may be adhered to a portion of an outer surface of the case 110 of the secondary battery 100. For example, the second fixing member 1100_2 may have a structure coated with a binder such as an adhesive material. The second fixing member 1100_2 (or the second binder layer) may be composed of a heat-resistant material. In this manner, the second fixing member 1100_2 may be stably attached to the outer surface of the case 110 despite temperature and pressure changes during the aging process. In addition, the fixing member 1100 may include a heat-resistant material that is not deformed by temperature changes during an aging process of the secondary battery 100. For example, the fixing member 1100 may include PET, PI, PP, or PTFE.

In an embodiment, the second fixing member 1100_2 may be in close contact with an outer surface of the case 110. For example, the second fixing member 1100_2 may have a surface geometry corresponding to the outer surface of the case 110, and may be in close contact with various outer surfaces such as flat or curved surfaces. For example, the second fixing member 1100_2 may have a certain roughness on its surface. This configuration may increase adhesion between the second fixing member 1100_2 and the outer surface of the case 110 and prevent the second fixing member 1100_2 from slipping. For example, the second fixing member 1100_2 may have a preset elasticity. This configuration may allow the second fixing member 1100_2 to deform in correspondence with a curvature of the outer surface of the case 110. This close contact structure may stably adhere the second fixing member 1100_2 to the outer surface of the case 110 to improve an effect of blocking electrolyte and gas leakage of the sealing member 1000.

In this manner, the sealing member 1000 may seal the electrolyte injection port 106, and the fixing member 1100 may closely adhere, fix, and/or maintain the sealing member 1000 to an outer surface of the case 110.

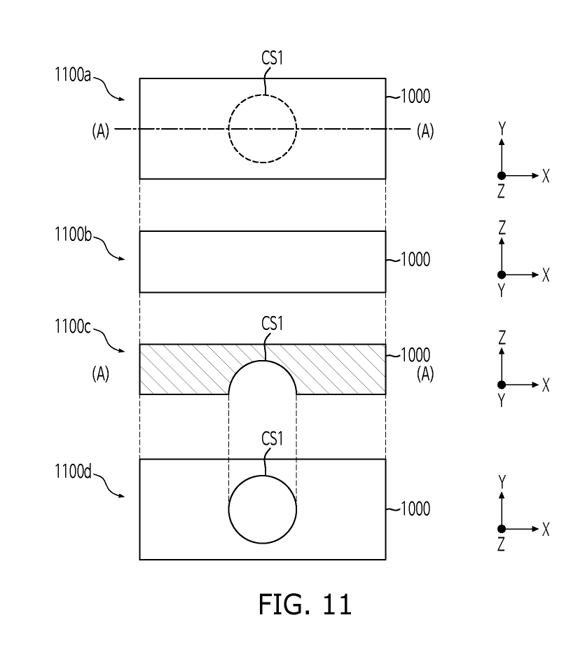

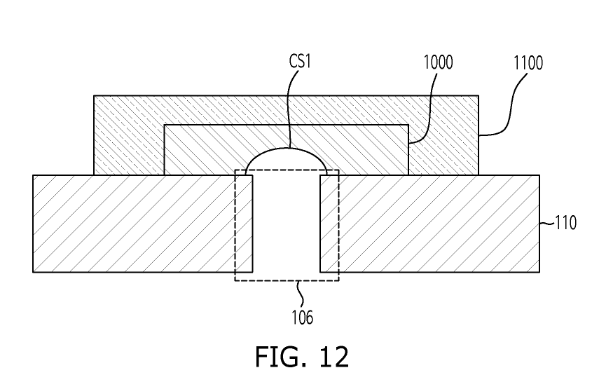

FIG. 11 is a diagram of a sealing member 1000. FIG. 12 is a cross-sectional view of a sealing structure including the sealing member 1000 of FIG. 11.

In an embodiment, the sealing structure may include a sealing member 1000 having a concave structure CS1 where one surface facing an electrolyte injection port is recessed, and a fixing member 1100 that fixes the sealing member 1000.

Referring to plan view 1100a, side view 1100b, A-A' cross-sectional view 1100c, rear view 1100d of FIG. 11, and cross-sectional view of FIG. 12, the sealing member 1000 may have a concave structure CS1 formed on one surface facing an electrolyte injection port 106 of the case 110. The concave structure CS1 exhibits a geometry in which a cross section gradually decreases as it goes in a direction perpendicular (Z) from the electrolyte injection port 106, and may provide a certain empty space such as a dome geometry between the sealing member 1000 and the electrolyte injection port 106. However, the geometry of the concave structure CS1 is not limited thereto, and may be formed in various geometries for guiding alignment and/or providing a buffer space of the concave structure CS1.

In an embodiment, the sealing member 1000 may include a transparent material and designed so that the concave structure CS1 is visible from the outside. This configuration may provide a visual guide that assists the sealing member 1000 to be accurately aligned on the electrolyte injection port 106, and ensure precision of sealing structure placement.

In an embodiment, the concave structure CS1 may provide a constant buffer space between the electrolyte injection port 106 and the sealing member 1000. Gas may be generated by a chemical reaction between an electrolyte and an electrode assembly during an aging process of a secondary battery. The buffer space provided by the concave structure CS1 may alleviate the pressure applied to the sealing member 1000, thereby allowing an adhesion state between the sealing member 1000 and the electrolyte injection port 106 to be stably maintained.

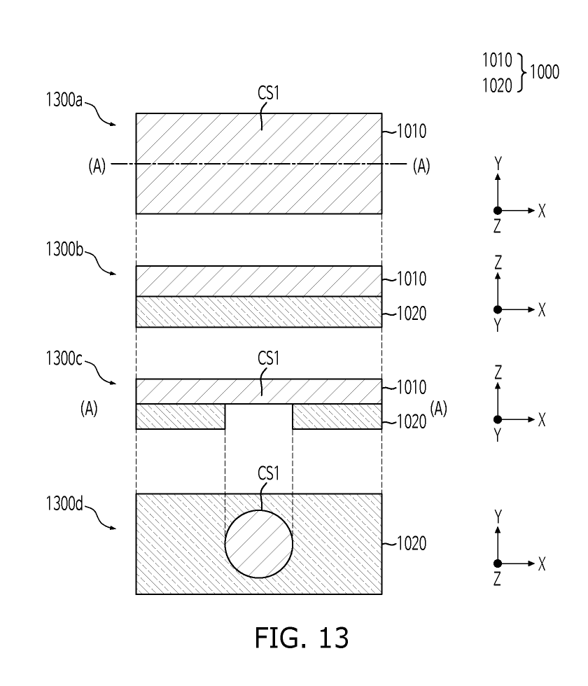

FIG. 13 is a diagram of a sealing member 1000.

In an embodiment, the sealing member 1000 is a multi-layered structure and may include a base layer 1010 in contact with an electrolyte injected into a case, and a binder layer 1020 disposed on one surface of the base layer.

Referring to plan view 1300a, side view 1300b, A-A' cross-sectional view 1300c, and rear view 1300d of FIG. 13, the base layer 1010 may include a material having chemical resistance and durability against an electrolyte and/or gas, and may be stably maintained despite being in contact with an electrolyte and/or gas. The binder layer 1020 is disposed between the base layer 1010 and an outer surface of a case, and may stably couple the base layer 1010 and the case. For example, the binder layer 1020 may maintain adhesion even in a relatively high temperature and relatively high pressure environment.

The base layer 1010 of the multi-layered sealing member 1000 provides chemical resistance to an electrolyte and gas, and the binder layer 1020 may ensure bonding strength and stability.

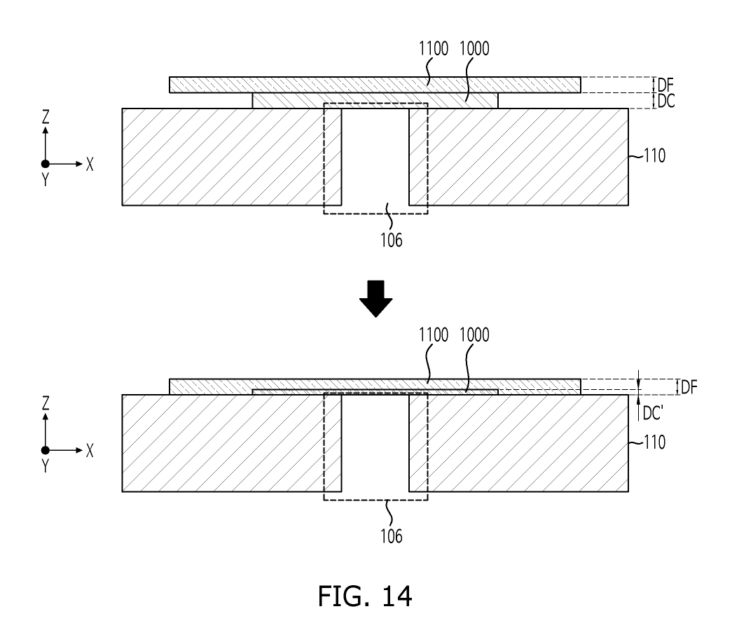

FIG. 14 is a diagram of a sealing. The sealing structure may include a sealing member 1000 and a fixing member 1100.

In an embodiment, the sealing member 1000 and the fixing member 1100 may be disposed on the electrolyte injection port 106 of the case 110. The sealing member 1000 and the fixing member 1100 may each have a certain thickness DC, DF. Here, a thickness of each member may indicate a length measured in a vertical direction (Z) from the electrolyte injection port 106.

In an embodiment, the sealing member 1000 and the fixing member 1100 may each have a predetermined elasticity. If pressure is applied to the sealing structure in a direction (-Z) toward the electrolyte injection port 106 or an outer surface of the case 110, at least a portion of the sealing member 1000 and the fixing member 1100 may be compressed from their original thicknesses DC, DF to specific thicknesses DC', DF' (DC'<DC, DF'<DF). This configuration may improve adhesion between the sealing member 1000 and the fixing member 1100. In addition, as the fixing member 1100 is in close contact with an outer surface of the case 110, adhesion between the fixing member 1100 and the outer surface of the case 110 may also be improved. This configuration may maintain a sealing performance of the sealing structure during an aging process, thereby preventing electrolyte and gas leakage.

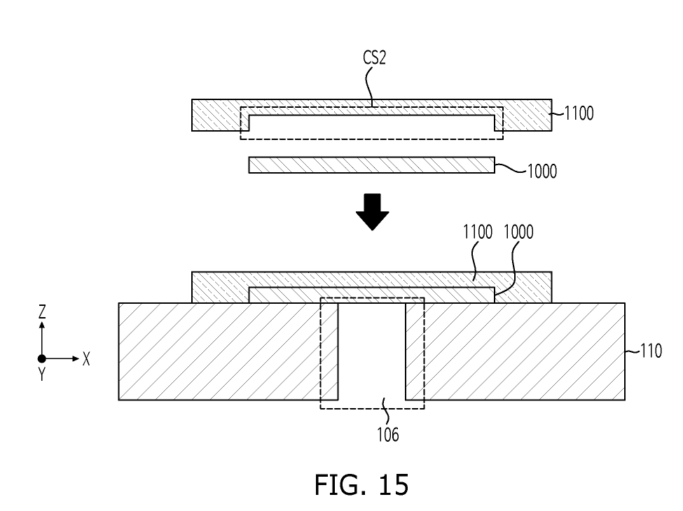

FIG. 15 is a diagram of a sealing structure.

In an embodiment, the sealing structure may include a sealing member 1000 and a fixing member 1100. The fixing member 1100 may include a concave structure CS2 that accommodates the sealing member 1000 on one surface to which the sealing member 1000 is attached.

The concave structure CS2 formed in the fixing member 1100 is shown as having the same size as the sealing member 1000, but is not limited thereto. For example, if the sealing structure is pressed to adhere to an outer surface of the case 110, a size/geometry of the sealing member 1000 and/or the fixing member 1100 may be deformed. In addition, a size/geometry of the sealing member 1000 and/or the fixing member 1100 may be deformed by temperature and pressure changes occurring during an aging process. The concave structure CS2 may be formed in the fixing member 1100 in consideration of these various environmental changes.

The concave structure CS2 formed in the fixing member 1100 may provide a guide to ensure that the sealing member 1000 is aligned at an accurate position on the electrolyte injection port 106, thereby improving convenience and precision of sealing structure placement.

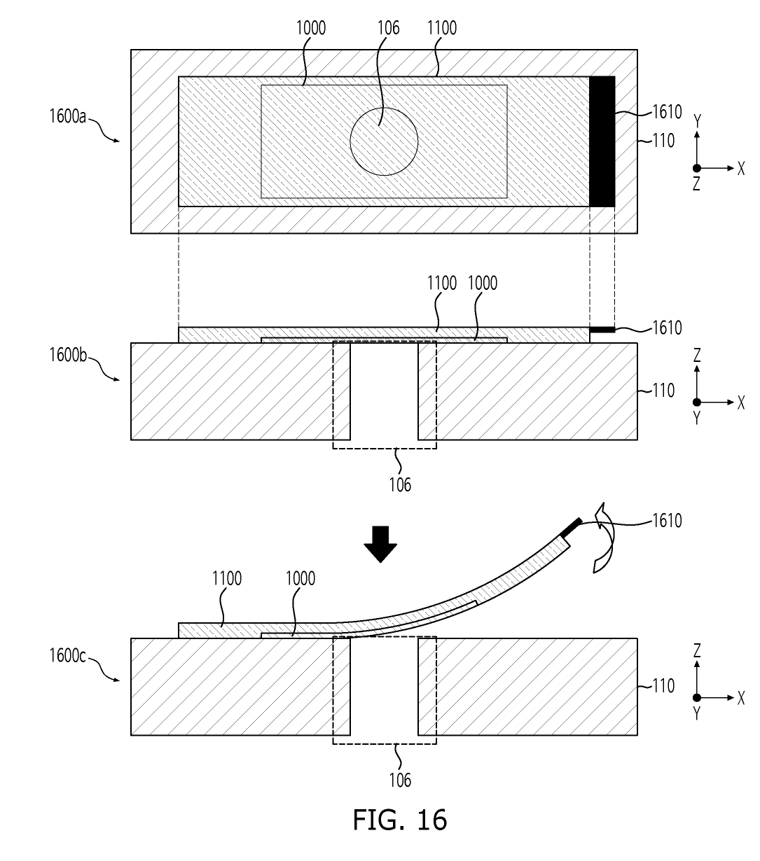

FIG. 16 is a diagram illustrating a process in which a sealing structure is removed. In an embodiment, the sealing structure may include a sealing member 1000, a fixing member 1100, and a first gripping portion 1610 extending from one side of the fixing member 1100. The sealing structure may be disposed on an outer surface of the case 110 such that the sealing member 1000 is placed on an electrolyte injection port 106.

Referring to plan view 1600a and cross-sectional views 1600b, 1600c of FIG. 16, at least a portion of the sealing structure may be removed from the case 110, and at least a portion of the electrolyte injection port 106 may be opened by pulling the first gripping portion 1610 in a direction (Z) perpendicular to an outer surface of the case 110.

Referring to plan view 1600aand cross-sectional view 1600b of FIG. 16, the first gripping portion 1610 may extend outward from at least a portion of one side surface of the fixing member 1100 in a direction (X) parallel to an outer surface of the case 110. In addition, the first gripping portion 1610 may be spaced apart from an outer surface of the case 110 by a predetermined distance. However, the geometry or arrangement structure of the first gripping portion 1610 is not limited thereto. The geometry, size, arrangement direction, or material, of the first gripping portion 1610 are not limited as long as at least a portion of the electrolyte injection port 106 can be easily opened by removing the sealing structure.

In this manner, the first gripping portion 1610 may facilitate removal of the sealing structure, thereby shortening an electrolyte injection process time.

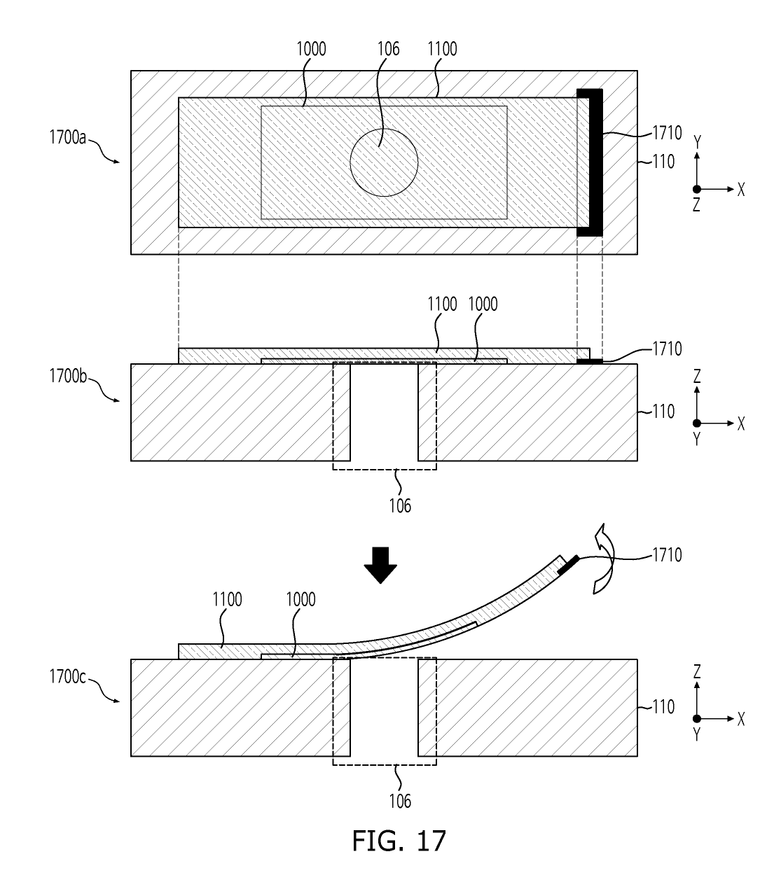

FIG. 17 is a diagram illustrating a process in which a sealing structure is removed. In an embodiment, the sealing structure may include a sealing member 1000, a fixing member 1100, and a second gripping portion 1710 extending from one side of the fixing member 1100. The sealing structure may be disposed on an outer surface of the case 110 such that the sealing member 1000 is placed on an electrolyte injection port 106.

Referring to plan view 1700a and cross-sectional views 1700b, 1700c of FIG. 17, the sealing structure is removed, and at least a portion of the electrolyte injection port 106 may be opened by pulling the second gripping portion 1710 in a direction (Z) perpendicular to an outer surface of the case 110.

Referring to plan view 1700a and cross-sectional view 1700b of FIG. 17, the second gripping portion 1710 may be formed to extend inward and outward from at least a portion of one side surface of the fixing member 1100 in a direction (X) parallel to an outer surface of the case 110. However, the arrangement structure of the second gripping portion 1710 is not limited thereto. The geometry, size, arrangement direction, or material of the second gripping portion 1710 are not limited as long as at least a portion of the electrolyte injection port 106 can be easily opened by removing the sealing structure.

In this manner, the second gripping portion 1710 may be firmly fixed to the fixing member 1100, and facilitate removal of the sealing structure, thereby shortening an electrolyte injection process time.

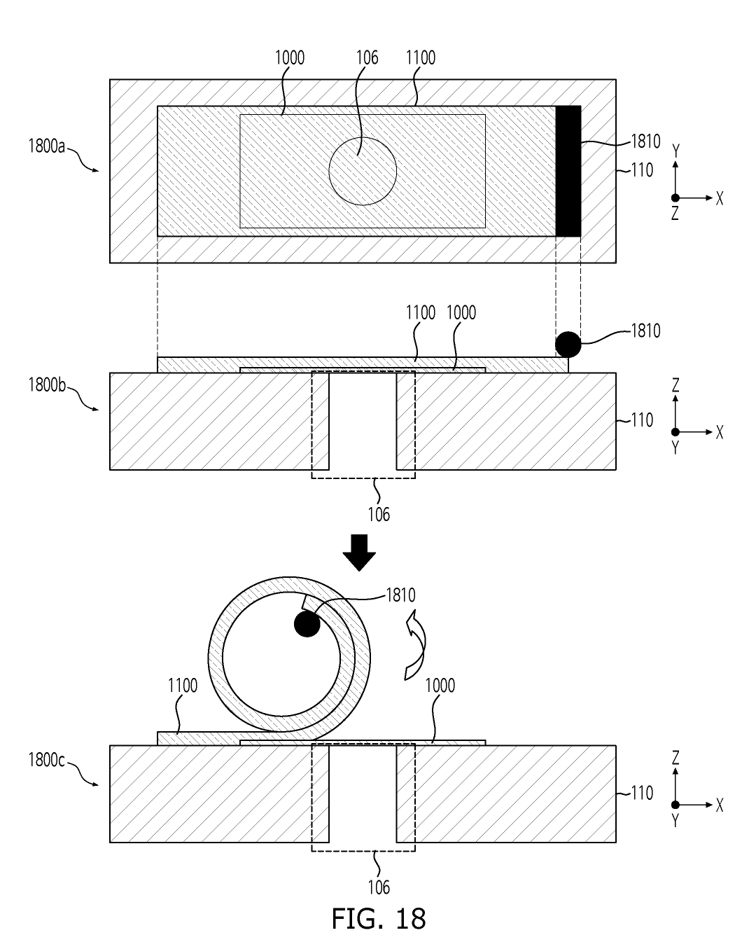

FIG. 18 is a diagram of a sealing structure. In an embodiment, the sealing structure may include a sealing member 1000, a fixing member 1100, and a third gripping portion 1810 extending from one side of the fixing member 1100. The sealing structure may be disposed on an outer surface of the case 110 such that the sealing member 1000 is placed on an electrolyte injection port 106.

Referring to plan view 1800a and cross-sectional views 1800b, 1800c of FIG. 18, the sealing structure is removed, and at least a portion of the electrolyte injection port 106 may be opened as the third gripping portion 1810 is wound in a first direction (-X) parallel to an outer surface of the case 110. Thereafter, if the third gripping portion 1810 is wound in a second direction (X) parallel to an outer surface of the case 110, the sealing structure may seal the electrolyte injection port 106 again.

Referring to plan view 1800a and cross-sectional view 1800b of FIG. 18, the third gripping portion 1810 is cylindrical and may be attached to an upper portion of one side surface of the fixing member 1100. The geometry or arrangement structure of the third gripping portion 1810 is not limited thereto. The geometry, size, arrangement direction, or material of the third gripping portion 1810 are not limited as long as at least a portion of the electrolyte injection port 106 can be easily opened by removing the sealing structure.

In this manner, the third gripping portion 1810 may facilitate opening or sealing of at least a part of the electrolyte injection port 106 by winding the sealing structure, thereby shortening an electrolyte injection process time.

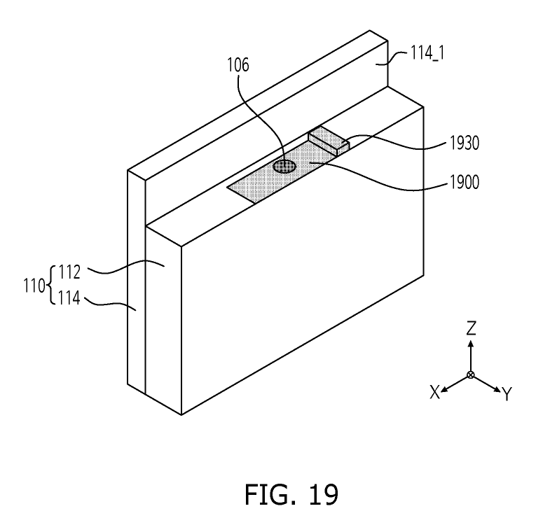

FIGS. 19-21 are diagrams illustrating sealing members 1900, 2000, 2100 including gripping portions 1930, 2030, 2130 being attached to a case. Referring to FIGS. 19-21, a case 110 of a secondary battery may include a case body 112 having an electrolyte injection port 106 formed on one surface thereof, and a case cover 114 coupled to the case body 112. A flange 114_1 for coupling with the case cover 114 may be formed on the case body 112. Sealing members 1900, 2000, 2100 for covering the electrolyte injection port 106 may be attached to one surface of the case body 112.

Referring to FIG. 19, the sealing member 1900 may include a gripping portion 1930 extending from one side of the sealing member 1900. The gripping portion 1930 may be formed to extend in a direction (e.g., X direction) along one surface of the case body 112 where the electrolyte injection port 106 is formed. The gripping portion 1930 may have a geometry for ease of grip for removing the sealing member 1900. For example, the gripping portion 1930 may be thicker and/or wider than the sealing member 1900, but is not limited thereto.

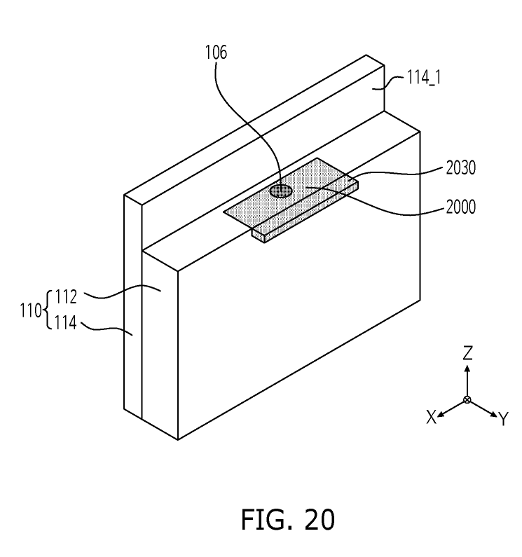

Referring to FIG. 20, a gripping portion 2030 of the sealing member 2000 may protrude in a thickness direction (e.g., Y direction) of the case body 112 from the case body 112 where the electrolyte injection port 106 is formed. In addition, the sealing member 2000 may be attached such that the gripping portion 2030 protrudes from the case body 112. Accordingly, the gripping portion 2030 may be easily gripped during the process of removing the sealing member 2000.

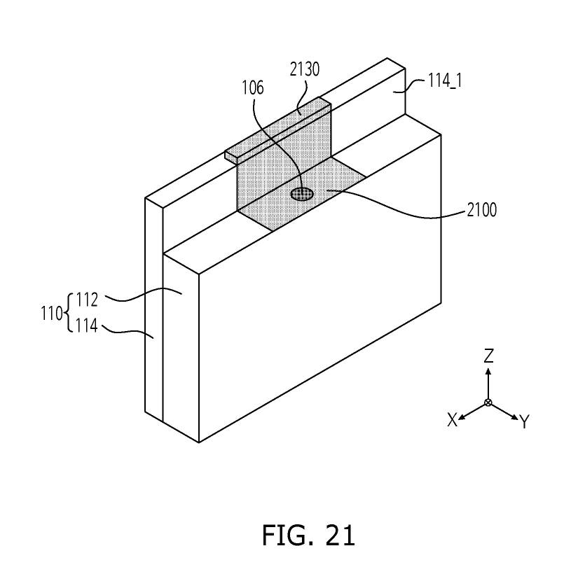

Referring to FIG. 21, the sealing member 2100 may surround one surface of the case body 112, where the electrolyte injection port 106 is formed, and the flange 114_1. In addition, the gripping portion 2130 may protrude beyond the flange 114_1 in a direction (e.g., Z direction) in which the flange 114_1 protrudes. Accordingly, the gripping portion 2130 may be easily gripped during the process of removing the sealing member 2100.

The geometries and arrangement structures of the gripping portions shown in FIGS. 19-21 are merely embodiments and are not limited thereto. That is, regardless of the geometry and material of the sealing members 1900, 2000, 2100, if the gripping portions 1930, 2030, 2130 are members that can facilitate the process of removing the sealing members 1900, 2000, 2100 from the case 110 of the secondary battery, their geometries, sizes, arrangement directions, and/or materials are not limited.

In addition, in FIGS. 19-21, the sealing members 1900, 2000, 2100 are shown and described as including gripping portions 1930, 2030, 2130, but are not limited thereto, and a sealing structure including the sealing members 1900, 2000, 2100 may include gripping portions 1930, 2030, 2130.

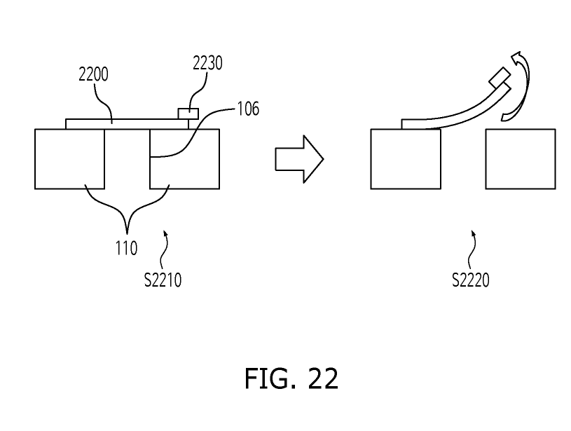

FIG. 22 is a diagram illustrating a process of removing a sealing member 2200. A process of attaching and/or removing the sealing member 2200 may be performed by at least one apparatus for manufacturing a secondary battery. However, it is not limited thereto, and the sealing member 2200 may be directly attached and/or removed by a person.

In an embodiment, the sealing member 2200 may be attached to one surface of the case 110 where an electrolyte injection port 106 is formed, so as to cover the electrolyte injection port 106 (S2210). The sealing member 2200 may perform a function of temporarily sealing the electrolyte injection port 106 to prevent an electrolyte from leaking during a pre-charging and/or aging process after the electrolyte is injected into the case 110.

If the pre-charging and/or aging process is completed, the sealing member 2200 may be removed from the case 110 (S2220). The sealing member 2200 may include a gripping portion 2230 for removing the sealing member 2200. The sealing member 2200 may be removed from the case 110 by being pulled while the gripping portion 2230 is gripped.

In an embodiment, the gripping portion 2230 may have a geometry for ease of grip for removing the sealing member 2200. For example, the gripping portion 2230 may be thicker than the sealing member 2200, or may be in a geometry protruding from an upper surface of the sealing member 2200. Accordingly, the sealing member 2200 is easily removed by the gripping portion 2230, thereby increasing an efficiency of an electrolyte injection process.

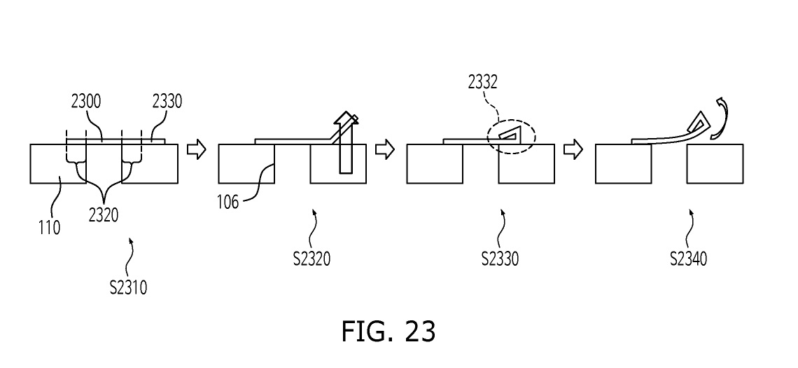

FIG. 23 is a diagram illustrating a process of removing a sealing member 2300.

In an embodiment, the sealing member 2300 may be attached to one surface of the case 110 where an electrolyte injection port 106 is formed, to cover the electrolyte injection port 106 (S2310). For example, a binder-applied region 2320 of the sealing member 2300 (e.g., 920_2 of FIG. 9) may be in contact with the case 110. After the sealing member 2300 is attached, a pre-charging and/or aging process of a secondary battery may be performed.

In an embodiment, the sealing member 2300 may include a gripping portion 2330 for removing the sealing member 2300. The gripping portion 2330 is a region where no binder is applied, and may protrude outward from a region 2320 where a binder is applied.

If the pre-charging and/or aging process is completed, the sealing member 2300 may be removed from the case 110. For example, while the sealing member 2300 is attached to the case 110, the gripping portion 2330 may be pulled (S2320). An end portion of the gripping portion 2330 may be bent to form a bending portion 2332, and the sealing member 2300 may be removed from the case 110 by being pulled while the bending portion 2332 is gripped (S2330, S2340).

In this manner, if the bending portion 2332 is formed during the process of removing the sealing member 1300, advantageously, the process of adding a separate configuration for facilitating gripping to the gripping portion 2330 may be omitted.

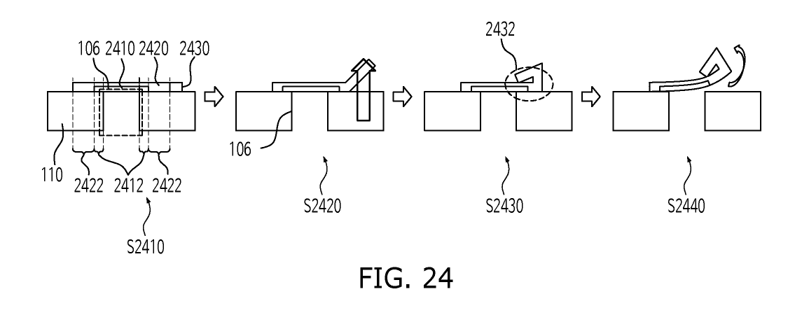

FIG. 24 is a diagram illustrating a process of removing a sealing structure. In an embodiment, the sealing structure may include a sealing member 2410 and fixing members 2420, 2430.

In a first step S2410, the sealing structure may be disposed on an outer surface of the case 110 such that the sealing member 2410 seals an electrolyte injection port 106 of the case 110. In an embodiment, a bending portion 2430 may be formed such that a portion of the fixing members 2420, 2430 is folded. For example, the sealing member 2410 may be attached to an outer surface of the case 110 in a first attachment region 2412. A portion 2420 of the fixing member may be attached to an outer surface of the case 110 in a second attachment region 2422. The bending portion 2430 may correspond to a member of the fixing member that is outside the attachment regions 2412, 2422 between the sealing structure and the case 110.

In a second step S2420 and a third step S2430, the bending portion 2430 may be pulled and wound into a handle shape 2432. In a fourth step S2440, the handle shape is pulled, and the sealing structure is removed, and at least a portion of the electrolyte injection port 106 may be opened.

In this manner, a process of forming a separate gripping portion on the sealing structure is omitted, thereby shortening a secondary battery manufacturing process. In addition, the bending portion may facilitate removal of the sealing structure, thereby shortening an electrolyte injection process or an aging process time.

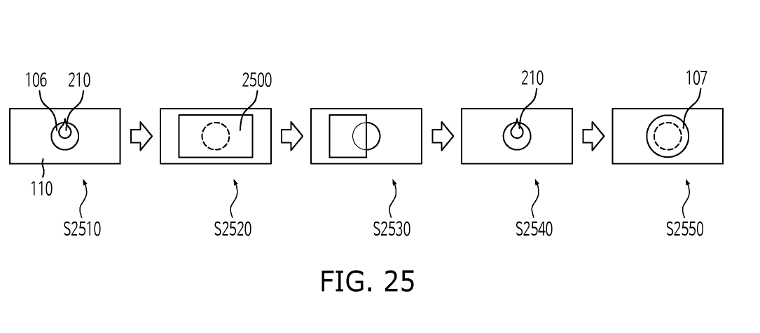

FIG. 25 is a diagram illustrating a process of manufacturing a secondary battery. FIG. 25 is a diagram illustrating an electrolyte injection port 106 of a secondary battery viewed from the exterior of a case 110.

A process of manufacturing a secondary battery may be initiated by primarily injecting an electrolyte 210 through an electrolyte injection port 106 formed on one surface of a case 110 accommodating an electrode assembly (S2510).

A sealing member 2500 may be attached to an outer surface of the case 110 to cover the electrolyte injection port 106 (S2520). The secondary battery with the electrolyte injection port 106 sealed may undergo a pre-charging and/or aging process. By sealing the electrolyte injection port 106 with the sealing member 2500, leakage of the electrolyte 210 or introduction of foreign matter into the electrolyte injection port 106 during the pre-charging and/or aging process may be prevented.

In an embodiment, the sealing member 2500 may include a base layer and a binder layer in which a binder is applied to a portion of one surface of the base layer. For example, the binder layer may include a first sealing member disposed on the electrolyte injection port 106 and exposing the base layer, and a second sealing member disposed to surround the first sealing member and having a binder applied thereto. As the first sealing member is aligned to be disposed on the electrolyte injection port 106, contamination of the electrolyte injection port by the binder may be prevented.

In an embodiment, a size of the first sealing member with a binder applied may be greater than a size of the electrolyte injection port 106. Accordingly, after the sealing member 2500 is removed, contamination of the area around the electrolyte injection port 106 by residual foreign matter of the binder may be prevented.

When the pre-charging and/or aging process is completed, the sealing member 2500 may be removed from one surface of the case 110 (S2530). For example, a gripping portion for gripping the sealing member 2500 may be formed on one side of the sealing member 2500. The sealing member 2500 may be removed by pulling the gripping portion in a direction away from one surface of the case 110.

The electrolyte 210 may be secondarily injected into the electrolyte injection port 106 exposed by removal of the sealing member 2500 (S2540). In addition, an enclosing member 107 may be inserted into the electrolyte injection port 106 to enclose the electrolyte injection port 106 (S2550). A pre-charging and/or aging process may be additionally performed on the secondary battery sealed by the enclosing member 107, but is not limited thereto.

In an embodiment, the enclosing member 107 may be welded to the case 110. For example, the enclosing member 107 may be welded to the case 110 along a welding line following the electrolyte injection port 106. In this case, the welding line may be smaller than a size of the first sealing member where a binder is applied to the sealing member 2500. Accordingly, during the process of welding the enclosing member 107 to the case 110, the welding line is not interfered with by binder residue, thereby preventing an enclosing force from being degraded by binder residue.

In FIG. 25, electrolyte 210 injection has been described as being performed a total of two times, but the number of electrolyte 210 injections and pre-charging and/or aging processes is not limited thereto.

In this manner, due to the utilization of the sealing member 2500 that can be repeatedly attached and removed without leaving residue around the electrolyte injection port 106, the electrolyte 210 may be continuously replenished in the secondary battery as many times as needed.

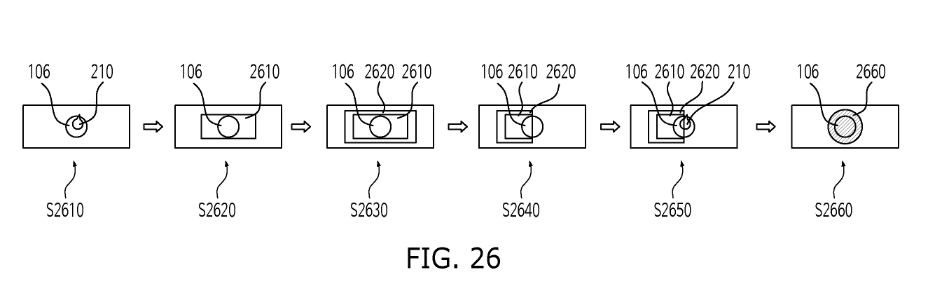

FIG. 26 is a diagram illustrating a method for manufacturing a secondary battery using a sealing structure. The sealing structure may include a sealing member 2610 and a fixing member 2620. Although a separate gripping portion is not shown in FIG. 26, it is not limited thereto. FIG. 26 illustrates an electrolyte being injected twice in an aging process, but is not limited thereto.

In step S2610, an electrolyte 210 may be primarily injected through an electrolyte injection port formed on one surface of a case 110 of a secondary battery.

In step S2620, the sealing member 2610 may be disposed on one surface of the case 110 to cover the electrolyte injection port 106.

After step S2620, in step S2630, the fixing member 2620 may be attached to one surface of the case 110 while covering one surface of the sealing member 2610 so that the sealing member 2610 is fixed to an outer surface of the case 110. Through step S2630 and step S2630, a primary aging process may be performed in a state where the electrolyte injection port 106 is sealed, and the primarily injected electrolyte 210 chemically reacts with the electrode assembly.

When the primary aging process is completed, in step S2640, at least a portion of the sealing structure is removed, and at least a portion of the electrolyte injection port 106 may be opened. In this manner, gas generated in the primary aging process may be discharged to the exterior of the case 110.

In step S2650, the electrolyte 210 may be secondarily injected through at least a portion of the opened electrolyte injection port 106. Although not shown in FIG. 26, the electrolyte injection port 106 may be sealed again with the sealing structure to perform a subsequent aging process. When the primary and subsequent aging processes are completed, the sealing structure may be completely removed from an outer surface of the case 110. After the aging process is completed, in a sixth step S2660, an enclosing member 2660 (e.g., a plug or a cover) may be inserted into the electrolyte injection port 106 to seal the electrolyte injection port 106. The enclosing member 2660 may be attached to the case 110 via welding, where the electrolyte injection port 106 is formed.

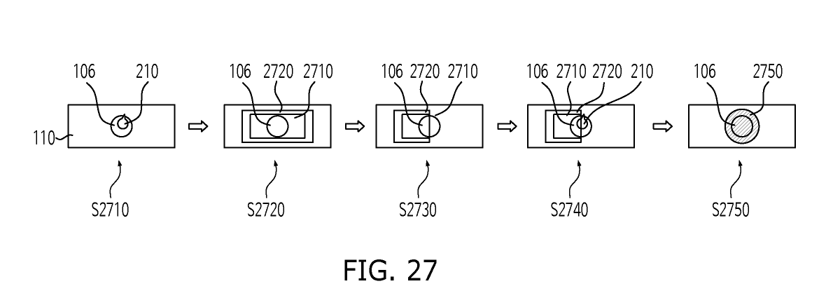

FIG. 27 is a diagram illustrating a method for manufacturing a secondary battery using a sealing structure. The sealing structure may include a sealing member 2710 and a fixing member 2720. Although a separate gripping portion is not shown in FIG. 27, it is not limited thereto. FIG. 27 illustrates an electrolyte being injected twice in an aging process, but is not limited thereto.

In step S2710, an electrolyte 210 may be primarily injected through an electrolyte injection port formed on one surface of a case 110 of a secondary battery.

In step S2720, the sealing member 2710 covers the electrolyte injection port 106, and a sealing structure, in which the sealing member 2710 and the fixing member 2720 are coupled, may be attached to one surface of the case 110, and the electrolyte injection port 106 may be sealed. Before step S2720, a sealing structure, in which the fixing member 2720 is attached to one surface of the sealing member 2710, may be prepared.

While the electrolyte injection port 106 is sealed in step S2720, the primarily injected electrolyte 210 chemically reacts with the electrode assembly, and a primary aging process may be performed.

When the primary aging process is completed, in step S2730, at least a portion of the sealing structure is removed, and at least a portion of the electrolyte injection port 106 may be opened. In this manner, gas generated in the primary aging process may be discharged to the exterior of the case 110.

In step S2740, the electrolyte 210 may be secondarily injected through at least a portion of the opened electrolyte injection port 106. Although not shown in FIG. 27, the electrolyte injection port 106 may be sealed again with the sealing structure to perform a subsequent aging process. When the primary and subsequent aging processes are completed, the sealing structure may be completely removed from an outer surface of the case 110. After the aging process is completed, in step S2750, an enclosing member 2750 may be inserted into the electrolyte injection port 106 to seal the electrolyte injection port. The enclosing member 2750 may be attached to the case via welding.

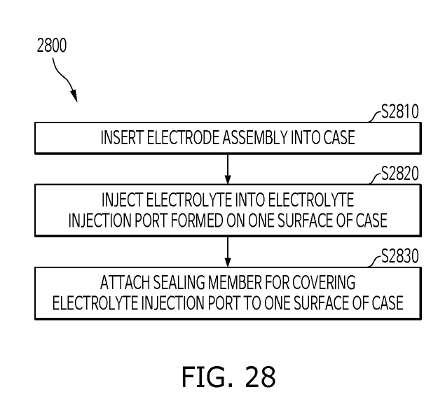

FIG. 28 is a flowchart illustrating a method for manufacturing a secondary battery 2800. In an embodiment, the method for manufacturing a secondary battery 2800 may be performed by an apparatus for manufacturing a secondary battery. The method for manufacturing a secondary battery 2800 may be initiated by the apparatus inserting an electrode assembly into a case (S2810). The apparatus may inject an electrolyte into an electrolyte injection port formed on one surface of the case (S2820).

The apparatus may attach a sealing member for covering the electrolyte injection port to one surface of the case (S2830). The sealing member may include a base layer and a binder layer in which a binder is applied to a portion of one surface of the base layer. In addition, the sealing member may include a first sealing member disposed on an electrolyte injection port and exposing the base layer, and a second sealing member surrounding the first sealing member and having a binder applied thereto.

In an embodiment, a size of the first sealing member may be greater than a size of an electrolyte injection port. For example, a width of the first sealing member may be about 2 mm to about 4 mm greater than a width of an electrolyte injection port, but is not limited thereto.

In an embodiment, the first sealing member may include a mark portion for aligning a position with respect to an electrolyte injection port of a secondary battery. Accordingly, the apparatus may identify the mark portion to attach a sealing member, and align the sealing member on an electrolyte injection port based on the identified mark portion.

For example, the mark portion may indicate a center of the first sealing member of the base layer. For example, the mark portion may indicate at least a portion of a circumference of the first sealing member. Additionally, the sealing member may be identified by different colors with the mark portion as a boundary.

In an embodiment, to attach a sealing member, the apparatus may identify an electrode terminal protruding from one surface of a case where an electrolyte injection port is formed. Based on a position of the identified electrode terminal, the sealing member may be aligned on an electrolyte injection port.

In an embodiment, the sealing member may further include a gripping portion extending from one side of the second sealing member. Accordingly, the apparatus may remove the sealing member using the gripping portion.

In an embodiment, the apparatus may inject an electrolyte into the electrolyte injection port exposed by removal of the sealing member. An enclosing member may be inserted into the electrolyte injection port to enclose the electrolyte injection port. For example, the apparatus may weld the enclosing member to the case along a welding line following a circumference of the electrolyte injection port. A size of a first region of the sealing member may be greater than the welding line.

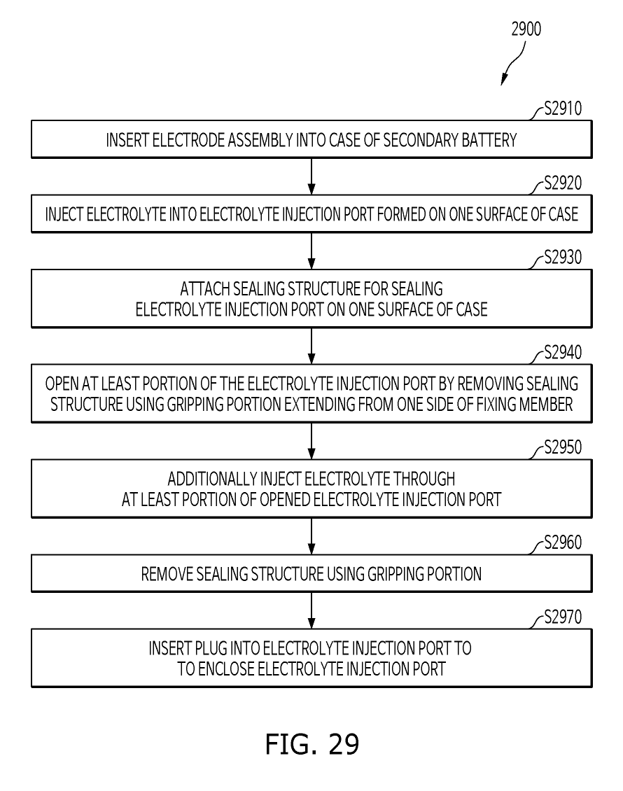

FIG. 29 is a flowchart illustrating a method for manufacturing a secondary battery.

A method for manufacturing a secondary battery 2900 may include inserting an electrode assembly into a case of a secondary battery (S2910), injecting an electrolyte into an electrolyte injection port formed on one surface of the case (S2920), attaching a sealing structure for sealing the electrolyte injection port on one surface of the case (S2930), opening at least a portion of the electrolyte injection port by removing the sealing structure using a gripping portion extending from one side of a fixing member (S2940), additionally injecting an electrolyte through at least a portion of the opened electrolyte injection port (S2950), removing the sealing structure using the gripping portion (S2960), and inserting a plug (or a enclosing member) into the electrolyte injection port to enclose the electrolyte injection port (S2970).

In an embodiment, in step S2930, an electrolyte injection port may be covered by one surface of a sealing member. A fixing member may be attached to the other surface of the sealing member. The sealing member may be fixed to a surface of the case by the fixing member.

In an embodiment, in step S2930, a fixing member may be attached to one surface of a sealing member. An electrolyte injection port may be covered by the other surface of the sealing member. A fixing member may be attached to one surface of the sealing member. The sealing member may be fixed to a surface of the case by the fixing member.

The flowcharts of FIGS. 28 and 29 and the corresponding description thereof are merely embodiments of the present disclosure, and the scope of the present disclosure is not limited to the flowcharts of FIGS. 28 and 29 and the description. For example, one or more steps in the flowcharts and the above description may be added/changed/deleted, an order of one or more steps may be changed, and one or more steps may be performed simultaneously.

Although the present disclosure has been described with reference to limited embodiments and drawings, the present disclosure is not limited thereto, and various modifications and variations are possible within the technical spirit of the present disclosure by those skilled in the art.

What is claimed is:

1. A sealing member comprising:
a first sealing member; and
a second sealing member surrounding the first sealing member,
wherein the first sealing member is configured to be disposed on an electrolyte injection port of a secondary battery,
wherein the second sealing member is configured to be disposed on an outer surface of a case of the secondary battery external to the electrolyte injection port, and
wherein no binder is applied to the first sealing member.

2. The sealing member as claimed in claim 1, wherein the first sealing member comprises a chemical-resistant material.

3. The sealing member as claimed in claim 1, wherein the first sealing member comprises a mark portion configured for aligning a position with respect to the electrolyte injection port of the secondary battery.

4. The sealing member as claimed in claim 3, wherein the mark portion indicates a center of the first sealing member or at least a portion of a circumference of the first sealing member.

5. The sealing member as claimed in claim 1, wherein a size of the first sealing member is greater than or equal to a size of the electrolyte injection port.

6. The sealing member as claimed in claim 1, further comprising a gripping portion extending from one side of the second sealing member.

7. The sealing member as claimed in claim 1, wherein the first sealing member has a concave structure having one surface facing the electrolyte injection port recessed.

8. The sealing member as claimed in claim 1, wherein the second sealing member comprises:
a base layer configured to be in contact with an electrolyte injected into the case; and
a binder layer configured to be disposed between one surface of the base layer and the outer surface of the case.

9. A sealing structure comprising:
a sealing member; and
a fixing member attached to one surface of the sealing member,
wherein the sealing member comprises:
a first sealing member configured to be disposed on an electrolyte injection port of a secondary battery and having no binder applied to the first sealing member; and
a second sealing member surrounding the first sealing member and configured to be disposed on an outer surface of a case of the secondary battery external to the electrolyte injection port, and
wherein the fixing member comprises:
a first fixing member attached to one surface of the sealing member; and
a second fixing member surrounding the first fixing member and disposed on the outer surface of the case external to the second sealing member.

10. The sealing structure as claimed in claim 9, further comprising a gripping portion extending from one side of the fixing member.

11. The sealing structure as claimed in claim 9, wherein the first fixing member comprises a base layer and a first binder layer disposed on one surface of the base layer, and
wherein the first binder layer is adhered to one surface of the sealing member.

12. The sealing structure as claimed in claim 9, wherein the second fixing member comprises a base layer and a second binder layer disposed on one surface of the base layer, and
wherein the second binder layer is adhered to a portion of the outer surface of the case of the secondary battery.

13. The sealing structure as claimed in claim 9, wherein the fixing member comprises a heat-resistant material.

14. The sealing structure as claimed in claim 9, wherein the fixing member has a concave structure having the sealing member accommodated on one surface to which the sealing member is attached.

15. A method for manufacturing a secondary battery comprising:
disposing an electrode assembly into a case;
injecting an electrolyte through an electrolyte injection port on the case; and
covering the electrolyte injection port using a sealing member,
wherein the sealing member comprises:
a first sealing member disposed on the electrolyte injection port and having no binder applied to the first sealing member; and
a second sealing member surrounding the first sealing member and disposed on an outer surface of the case external to the electrolyte injection port.

16. The method as claimed in claim 15, wherein the first sealing member comprises a mark portion for aligning a position with respect to the electrolyte injection port of the secondary battery, and
wherein the covering comprises:
identifying the mark portion; and
aligning the sealing member to the electrolyte injection port based on the mark portion.

17. The method as claimed in claim 15, wherein the covering comprises:
identifying an electrode terminal protruding from one surface of the case; and
aligning the sealing member to the electrolyte injection port based on a position of the electrode terminal.

18. The method as claimed in claim 15, wherein the sealing member further comprises a gripping portion extending from one side of the second sealing member, and
wherein the method further comprises removing the sealing member using the gripping portion.

19. The method as claimed in claim 18, further comprising:
further injecting the electrolyte through the electrolyte injection port exposed by removal of the sealing member; and
enclosing the electrolyte injection port via an enclosing member.

20. The method for manufacturing a secondary battery as claimed in claim 19, wherein the enclosing comprises welding the sealing member to the case.
